(19) United States
(12) Patent Application Publication
(10) Pub. No.: US 2015/0095312 A1
(43) Pub. Date: Apr. 2, 2015

(54) EXTRACTING RELATIONAL DATA FROM SEMI-STRUCTURED SPREADSHEETS

(71) Applicant: Microsoft Corporation, Redmond, WA (US)

(72) Inventors: Sumit Gulwani, Bellevue, WA (US); Benjamin G. Zorn, Woodinville, WA (US); Daniel W. Barowy, South Deerfield, MA (US); Edward Hart, Redmond, WA (US)

(73) Assignee: Microsoft Corporation, Redmond, WA (US)

(21) Appl. No.: 14/044,063

(22) Filed: Oct. 2, 2013

(51) Int. Cl. G06F 17/30

(52) U.S. Cl. CPC G06F 17/30595; G06F 17/30339
USPC 707/722

(57) ABSTRACT

Relational data is extracted from spreadsheets. A relational data extraction program is synthesized, where this synthesized program is consistent with examples of relational data associated with a spreadsheet. The synthesized program is executed on the spreadsheet, which extracts a set of tuples therefrom that is consistent with these examples, and generates a table that includes the extracted set of tuples. A program is received that specifies a set of constraints defining relational data to be extracted from a spreadsheet, where this set of constraints includes cell constraints and spatial constraints. The received program is executed on the spreadsheet, which extracts a set of tuples therefrom that is consistent with the set of constraints, and generates a table that includes the extracted set of tuples.

### BACKGROUND

The information technology revolution over the past several decades has resulted in the digitization of massive amounts of data and widespread user access to computing devices. More than 500 million people worldwide currently use spreadsheets and other tabular data formats for organizing, analyzing, manipulating, storing, and presenting various types of data in a wide variety of application contexts. These people include a myriad of end-users having diverse backgrounds such as commodity traders, graphic designers, chemists, human resource managers, finance professionals, marketing managers, underwriters, compliance officers, and even mailroom or stockroom clerks.

Many different types of data can be organized, analyzed, manipulated and stored in spreadsheets. Examples of such data-types include text, numeric values, functions, and various types of image and graphics objects. Spreadsheets store data in one or more two-dimensional arrays of cells which are known as worksheets, where each worksheet is organized in rows and columns. Each cell in each worksheet can store either a given text string, or a given numeric value, or a given image or graphics object. Each cell in each worksheet can also store a given user-defined function that automatically calculates and displays a value that is based on the contents of one or more other cells in the spreadsheet (in other words, the contents of a given cell can be based on the contents of one or more other cells). This function can include a wide variety of different types of computational functions, computational operators, and conditional expressions. As such, a cell in a given worksheet can reference one or more other cells in the worksheet, or one or more other cells in one or more other worksheets. A user of a spreadsheet can thus interactively make changes in any data that is stored in the spreadsheet and observe the effects on calculated values in the spreadsheet.

Given the foregoing, it will be appreciated that spreadsheets represent a major source of semi-structured data. It will also be appreciated that complex structures of multi-dimensional and hierarchical data can be stored in spreadsheets.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Data extraction technique embodiments described herein are generally applicable to extracting relational data from spreadsheets. In one exemplary embodiment the spreadsheet is received and an objectives relational table is received, where this table includes one or more examples of relational data associated with the spreadsheet. A relational data extraction program that is consistent with these examples is then synthesized. This synthesized program is then executed on the spreadsheet, where this execution automatically extracts a set of tuples from the spreadsheet that is consistent with the examples, and generates a results relational table that includes the extracted set of tuples.

In another exemplary embodiment a spreadsheet is received and a program is received, where the received program specifies a set of constraints defining relational data that is to be extracted from the spreadsheet, and this set of constraints includes one or more cell constraints and one or more spatial constraints. The received program is then executed on the spreadsheet, where this execution automatically extracts a set of tuples from the spreadsheet that is consistent with the set of constraints, and generates a table that includes the extracted set of tuples.

In yet another exemplary embodiment relational data in a spreadsheet is transformed into a desired format. The spreadsheet is transmitted and an objectives relational table is transmitted, where this table includes one or more examples of relational data associated with the spreadsheet. A results relational table is then received, where this received table includes a set of tuples that has been automatically extracted from the spreadsheet, where this set of tuples is consistent with these examples.

### DESCRIPTION OF THE DRAWINGS

The specific features, aspects, and advantages of the data extraction technique embodiments described herein will become better understood with regard to the following description, appended claims, and accompanying drawings where:

FIG. 1 illustrates an exemplary embodiment, in simplified form, of a spreadsheet that exhibits headers, multi-level headers, and repeated tables features.

FIG. 2 illustrates an exemplary embodiment, in simplified form, of a normalized relational representation of the underlying data in the spreadsheet shown in FIG. 1. FIG. 2 also illustrates an exemplary embodiment, in simplified form, of a results relational table that can be generated by the data extraction technique embodiments described herein.

FIG. 3A illustrates an exemplary embodiment, in simplified form, of a spreadsheet that exhibits a side-by-side records feature, where each row of the spreadsheet includes a plurality of records. FIG. 3B illustrates an exemplary embodiment, in simplified form, of a tree structure representation of a relational data extraction program that is graphically overlaid on top of the spreadsheet shown in FIG. 3A.

FIG. 4 illustrates an exemplary embodiment, in simplified form, of a normalized relational representation of the underlying data in the spreadsheet shown in FIG. 3A. FIG. 4 also illustrates another exemplary embodiment, in simplified form, of a results relational table that can be generated by the data extraction technique embodiments described herein.

FIG. 5 illustrates an exemplary embodiment, in simplified form, of a spreadsheet that exhibits omitted attributes and white space features.

FIG. 6 illustrates an exemplary embodiment, in simplified form, of a normalized relational representation of the underlying data in the spreadsheet shown in FIG. 5. FIG. 6 also illustrates yet another exemplary embodiment, in simplified form, of a results relational table that can be generated by the data extraction technique embodiments described herein.

FIG. 7A is a listing illustrating an exemplary embodiment, in simplified form, of the syntax of a query language of the data extraction technique embodiments described herein. FIG. 7B is a listing illustrating an exemplary embodiment, in simplified form, of the types that are used in the query language. FIG. 7C is a listing illustrating an exemplary embodiment, in simplified form, of a shorthand syntax that is used in the query language for notational convenience. FIG. 7D is a listing illustrating an exemplary embodiment, in simplified form, of the semantics of the query language.

FIG. 8 is a flow diagram illustrating an exemplary embodiment, in simplified form, of a process for executing a given relational data extraction program on a given spreadsheet, where the program is generated by the data extraction technique embodiments described herein.

FIG. 9A is a listing illustrating an exemplary embodiment, in simplified form, of a program that can be generated by the data extraction technique embodiments described herein, where this program extracts relational data from the spreadsheet shown in FIG. 3A and generates the results relational table which includes the extracted relational data shown in FIG. 4. FIG. 9B is a schematic diagram illustrating a tree structure representation of the program shown in FIG. 9A.

FIG. 10 illustrates an exemplary embodiment, in simplified form, of a set of cells (highlighted) from the spreadsheet shown in FIG. 3A that satisfy the cell constraint for the root node that is specified in the first line of the program shown in FIG. 9A.

FIG. 11A illustrates an exemplary embodiment, in simplified form, of a program listing for a single iteration of a program synthesis procedure of the data extraction technique embodiments described herein. FIG. 11B illustrates an exemplary embodiment, in simplified form, of a program listing for a search subroutine of the program listing shown in FIG. 11A. FIG. 11C illustrates an exemplary embodiment, in simplified form, of a cell constraint learning subroutine of the program listing shown in FIG. 11A. FIG. 11D illustrates an exemplary embodiment, in simplified form, of a program listing for a spatial constraint learning subroutine of the program listing shown in FIG. 11A. FIG. 11E illustrates an exemplary embodiment, in simplified form, of a program listing for a subroutine that learns the direction and the amount of spacing between examples provided by a user that specify the kinds of relational data that the user desires to be extracted from a spreadsheet.

FIG. 12 is a flow diagram illustrating an exemplary embodiment, in simplified form, of a process for automatically synthesizing a given valid relational data extraction program.

FIG. 13 illustrates an exemplary embodiment, in simplified form, of another spreadsheet.

FIG. 14 illustrates an exemplary embodiment, in simplified form, of a results relational table that can be generated by an exemplary relational data extraction program which can be automatically synthesized by the data extraction technique embodiments described herein to extract relational data from the spreadsheet shown in FIG. 13.

FIG. 15 is a listing illustrating an exemplary embodiment, in simplified form, of a partial set of regular expressions that can be learned by the program synthesis procedure of the data extraction technique embodiments described herein.

FIG. 16 is a listing illustrating an exemplary embodiment, in simplified form, of a set of candidate cell constraints that can be learned by the program synthesis procedure of the data extraction technique embodiments described herein.

FIG. 17 is a table illustrating an exemplary embodiment, in simplified form, of a set of candidate spatial constraints that can be learned by the program synthesis procedure of the data extraction technique embodiments described herein.

FIG. 18 is a schematic diagram illustrating an exemplary embodiment, in simplified form, of an interim tree structure representation of a candidate relational data extraction program that is in the process of being automatically synthesized by the program synthesis procedure of the data extraction technique embodiments described herein after a spatial constraint from node 2 to node 1 has been selected.

FIG. 19 is a schematic diagram illustrating an exemplary embodiment, in simplified form, of a completed tree structure representation of a candidate relational data extraction program that has been automatically synthesized by the program synthesis procedure of the data extraction technique embodiments described herein. More particularly, FIG. 19 illustrates a completed version of the interim tree structure shown in FIG. 18.

FIG. 20 illustrates an exemplary embodiment, in simplified form, of a results relational table that can be generated by the data extraction technique embodiments described herein when a single positive example ordered tuple is used to extract relational data from the spreadsheet shown in FIG. 13.

FIG. 21 is a flow diagram illustrating one embodiment, in simplified form, of a process for automatically extracting relational data from a spreadsheet.

FIG. 22 is a flow diagram illustrating an exemplary embodiment, in simplified form, of a process for allowing a user to automatically transform relational data in a spreadsheet into a desired format.

FIG. 23 is a flow diagram illustrating another embodiment, in simplified form, of a process for automatically extracting relational data from a spreadsheet.

FIG. 24 is a diagram illustrating a simplified example of a general-purpose computer system on which various embodiments and elements of the data extraction technique, as described herein, may be implemented.

### DETAILED DESCRIPTION

In the following description of data extraction technique embodiments reference is made to the accompanying drawings which form a part hereof, and in which are shown, by way of illustration, specific embodiments in which the data extraction technique can be practiced. It is understood that other embodiments can be utilized and structural changes can be made without departing from the scope of the data extraction technique embodiments.

It is also noted that for the sake of clarity specific terminology will be resorted to in describing the data extraction technique embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the data extraction technique. The appearances of the phrases “in one embodiment”, “in another embodiment”, “in an exemplary embodiment”, “in an alternate embodiment”, “in one implementation”, “in another implementation”, “in an exemplary implementation”, and “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the data extraction technique does not inherently indicate any particular order not imply any limitations of the data extraction technique.

### 1.0 Semi-Structured Spreadsheets

Generally speaking and as is appreciated in the art of spreadsheets, the flexibility of spreadsheets allows users to combine data definitions and data views, providing ease of data entry and readability at the expense of ease of data manipulation or querying. Conventional spreadsheet applications and systems provide their users with a large number of useful features for data reformatting, analysis and visualization. Examples of such features are described in more detail hereafter. However, many of these features (such as pivoting, array functions, and charting, to name a few) are based on the spreadsheet data being in a structured format (more particularly, a contiguous relational format). Users often store multi-dimensional data (e.g., hierarchical or tree-shaped data) in two-dimensional spreadsheets in a semi-structured fashion. The symmetric, two-dimensional structure of a spreadsheet's one or more worksheets provides a natural way for users to store two-dimensional data. For higher-dimensional data, users often use sub-headers to embed additional dimensions in the spreadsheet data, which mixes the data definition and the view. As is appreciated in the art of spreadsheets, this usage of sub-headers to embed additional dimensions in the spreadsheet data is advantageous to spreadsheet users since it provides ease of use and allows them to be creative when they are defining visual layouts of the data. However, there is no standardization or tool support for such usage of sub-headers.

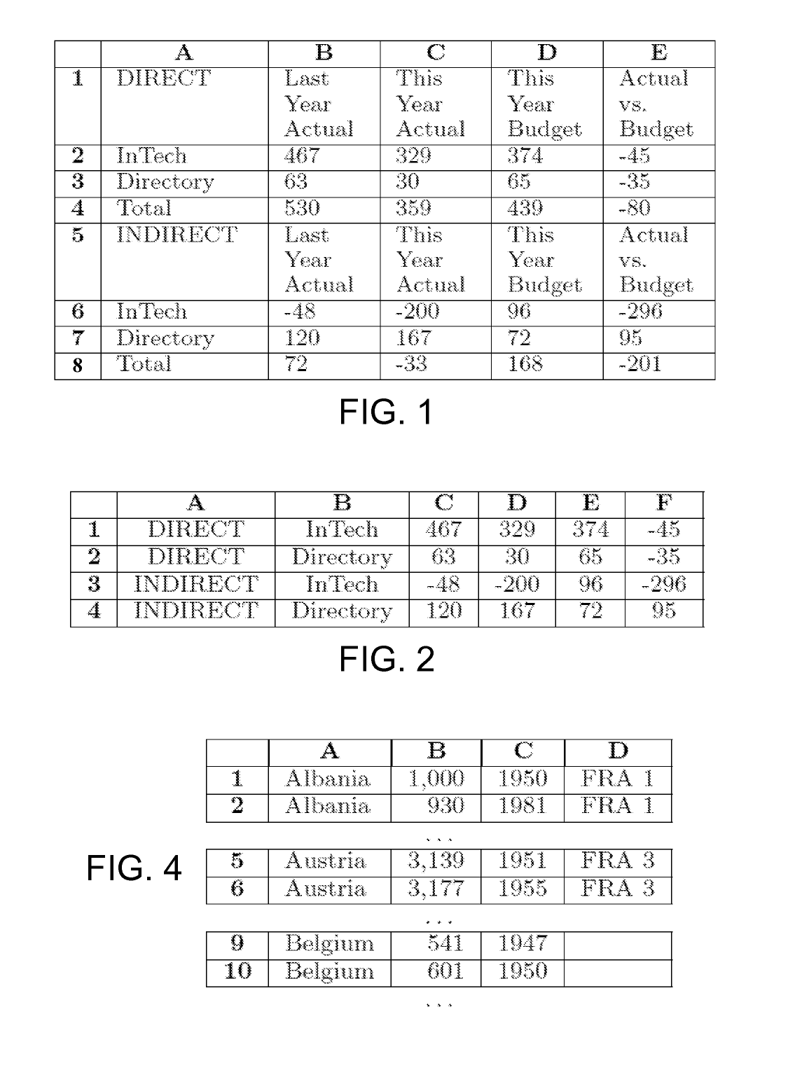

FIG. 1 illustrates an exemplary embodiment, in simplified form, of a spreadsheet that exhibits headers and multi-level headers features. The particular spreadsheet shown in FIG. 1 is an excerpt of a financial spreadsheet (03PFMJOURnalBOOKSFinaA7ED3.xls) that is drawn from the EUSES (End Users Shaping Effective Software) spreadsheet corpus. As exemplified in FIG. 1, the header label “InTech” in row 2 of the spreadsheet refers to all of the cells that are horizontally to the right of this label. The header label “Last Year Actual” in column B of the spreadsheet refers to all of the cells that are vertically beneath this label. The multi-level header labels “DIRECT” and “INDIRECT” each span three rows in the spreadsheet, meaning that the label “DIRECT” is applied to all of the cells in rows 2-4, and the label “INDIRECT” is applied to all of the cells in rows 6-8. The spreadsheet shown in FIG. 1 also exhibits a repeated tables feature (more particularly a vertical sub-tables feature), where different multi-level header labels (namely “DIRECT” and “INDIRECT”) are used in each sub-table. It is noted that the other sub-tables in the spreadsheet, and their multi-level header labels (e.g., “REVENUE”, “EXPENSES”, and “SURPLUS”) are not shown in FIG. 1 due to space constraints. Spreadsheet users favor entering data in the style exemplified in FIG. 1 because the data is presented compactly, thus making the data both easy to read and easy to enter. Additionally, the repeated tabular structure exemplified in FIG. 1 aids a user's eyes by putting significant semantic information nearby. The spreadsheet shown in FIG. 1 is thus easy for a user to interpret/absorb at a glance.

FIG. 2 illustrates an exemplary embodiment, in simplified form, of a normalized relational representation of the underlying data in the spreadsheet shown in FIG. 1. In contrast to the spreadsheet shown in FIG. 1, the spreadsheet shown in FIG. 2 is not easy for a user to interpret/absorb at a glance. In further contrast to the spreadsheet shown in FIG. 1, it is tedious for a user to input large amounts of data in the format shown in FIG. 2 since information such as “InTech” would have to be repeatedly entered. However, it is noted that the data format in FIG. 2 can be easily manipulated or queried by using the rich spreadsheet functionality that is restricted to a continuous arrangement of relational tabular data.

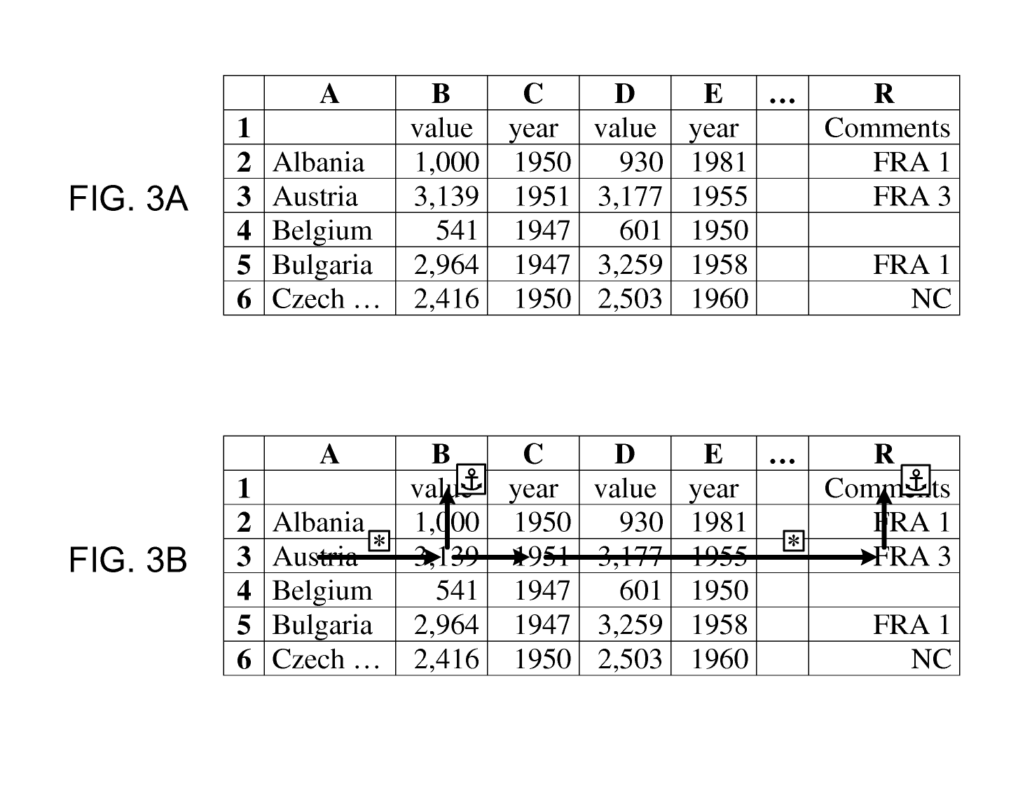

FIG. 3A illustrates an exemplary embodiment, in simplified form, of a spreadsheet that exhibits a side-by-side records feature. The particular spreadsheet shown in FIG. 3A is an excerpt of a spreadsheet detailing European timber exports in hectares (03-1-report-annex-5.xls) that is drawn from the EUSES spreadsheet corpus. As exemplified in FIG. 3A, the records for “Belgium” are arranged side-by-side, from left to right, in pairs of “value” and “year”. The records for other countries (e.g., “Austria” and “Bulgaria”) repeat vertically. A “Comments” field is appended to the records for each country on the far right of each row in the spreadsheet, applying information to the entire row. FIG. 3B illustrates an exemplary embodiment, in simplified form, of a tree representation of a relational data extraction program that is graphically overlaid on top of the spreadsheet shown in FIG. 3A. As will be appreciated from the more detailed description that follows, this program can be created by the data extraction technique embodiments described herein and can be used to extract a set of tuples of relational data from the underlying spreadsheet.

FIG. 4 illustrates an exemplary embodiment, in simplified form, of a normalized relational representation of the underlying data in the spreadsheet shown in FIG. 3A. In contrast to the spreadsheet shown in FIG. 3A, the spreadsheet shown in FIG. 4 is significantly more verbose and significantly less compact.

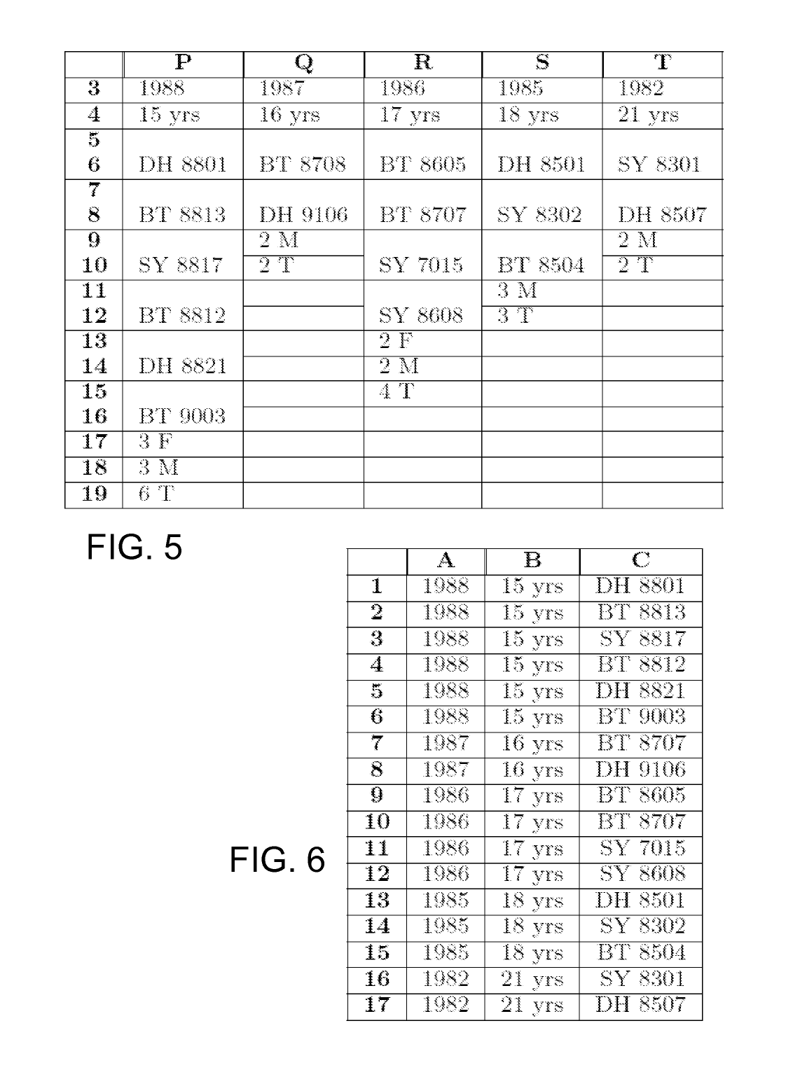

FIG. 5 illustrates an exemplary embodiment, in simplified form, of a spreadsheet that exhibits an omitted attributes feature. The particular spreadsheet shown in FIG. 5 is an excerpt of a spreadsheet describing a population of horses at the Pryor Mountain Wild Horse Range (2003 Final PopAgeStruct.xls) that is drawn from the EUSES spreadsheet corpus. As exemplified in FIG. 5, attributes are omitted from the spreadsheet resulting in an idiosyncratic layout that provides a downward-accumulating histogram-like summary of the horse population, where each cell includes information pertaining to individual horses. This creative spatial arrangement maximizes the spreadsheet's visual appeal and minimizes clutter therein. The spreadsheet shown in FIG. 5 also exhibits a white space feature. Spreadsheet users often use white space in their spreadsheets to visually distinguish certain cells therein. As further exemplified in FIG. 5, cells which include information about individual horses are separated by an empty cell. Although this white space includes no information content, it serves to guide a user's eye to the semantically meaningful parts of the spreadsheet, thus making it easier for the user to interpret/absorb the spreadsheet at a glance.

FIG. 6 illustrates an exemplary embodiment, in simplified form, of a normalized relational representation of the underlying data in the spreadsheet shown in FIG. 5. In contrast to the spreadsheet shown in FIG. 5, the spreadsheet shown in FIG. 6 is not easy for a user to interpret/absorb at a glance.

Given the various exemplary spreadsheet embodiments that were just described, it will be appreciated that spreadsheets can mix presentation information (such as spatial layout, color, and other types of style information) with data. It will also be appreciated that the unconstrained nature of spreadsheet layouts means that functions which would otherwise be simple in a relational database can become complex in a spreadsheet. It will also be appreciated that spreadsheets are inherently two-dimensional and as such, high-dimensional data is often stored in a spreadsheet in creative ways.

As will be appreciated from the more detailed description that follows, the data extraction technique embodiments described herein are advantageous in that they allow relational data to be automatically extracted from spreadsheets despite the just-described factors. By way of example but not limitation, the data extraction technique embodiments can traverse the complex structures of multi-dimensional and hierarchical data that can be stored in spreadsheets. The data extraction technique embodiments can also deal with the inconsistencies of these data structures, and are sensitive to any presentation information therein. More particularly and by way of further example but not limitation, suppose a user wants to know how many horses of age 17 or greater there are in the spreadsheet shown in FIG. 5. The data extraction technique embodiments can extract this information from this spreadsheet by automatically selecting groups of cells according to a header and then counting them while being careful to omit meaningless white space.

### 2.0 Extracting Relational Data from Semi-Structured Spreadsheets

The data extraction technique embodiments described herein involve both a query language and a program synthesis procedure either of which can be used to automatically extract relational data from semi-structured spreadsheets that may include multi-dimensional data (hereafter simply referred to as spreadsheets). In other words, the data extraction technique embodiments allow a user to automatically transform relational data in a spreadsheet into a desired format. Generally speaking and as will be described in more detail hereafter, the query language of the data extraction technique embodiments can be used by a programmer (among other types of people) to manually create a program that automatically extracts relational data from a spreadsheet and outputs the extracted relational data in the form of a relational table. The program synthesis procedure of the data extraction technique embodiments can be used by an end-user (e.g., someone who is not a programmer) to automatically synthesize a program in the query language that automatically extracts relational data from a spreadsheet based on one or more examples of the kinds of relational data that the end-user desires to be extracted from the spreadsheet (hereafter sometimes simply referred to as data extraction examples), where this synthesized program outputs the extracted relational data in the form of a relational table.

The data extraction technique embodiments described herein also involve various processes for automatically extracting relational data from spreadsheets, and for allowing a user to transform relational data in spreadsheets into a desired format. As will be appreciated from the more detailed description that follows, one of these processes leverages the query language of the data extraction technique embodiments and is hereafter simply referred to as the programming process implementation of the data extraction technique embodiments. Others of these processes leverage the program synthesis procedure of the data extraction technique embodiments and are hereafter collectively simply referred to as the program synthesis process implementations of the data extraction technique embodiments.

The data extraction technique embodiments described herein are advantageous for various reasons including, but not limited to, the following. As will be appreciated from the more detailed description that follows, the data extraction technique embodiments can extract relational data from spreadsheets that include a wide variety of data-types including, but not limited to, the exemplary data-types described heretofore. The data extraction technique embodiments also allow spreadsheet users to use sub-headers to embed the aforementioned additional dimensions in data. The data extraction technique embodiments also allow spreadsheet users to use the many different conventional spreadsheet features and functions that are available for relationally formatted data.

The query language and programming process implementation of the data extraction technique embodiments described herein are advantageous for various reasons including, but not limited to, the following. The query language and programming process implementation allow programmers to create programs that are expressive enough to extract desired data relations/patterns from the aforementioned complex structures of multi-dimensional and hierarchical relational data that can be stored in spreadsheets. The query language is thus an effective tool for expressing spatial and textual pattern-based queries that specify desired relational data extractions from spreadsheets. The query language is also relatively easy for programmers to learn because it builds on their experience using regular expressions.

The program synthesis procedure and program synthesis process implementations of the data extraction technique embodiments described herein are advantageous for various reasons including, but not limited to, the following. The program synthesis procedure and program synthesis process implementations allow non-programmers (e.g., end-users with no programming experience, and no knowledge of regular expressions and spatial reasoning) to efficiently create such programs by simply providing a small number of data extraction examples. In fact, depending on the particular type of spreadsheet that an end-user is extracting relational data from (e.g., depending on the particular structure of the spreadsheet and the particular type(s) of data therein), the end-user may need to provide just one data extraction example. The programs that are synthesized by the program synthesis procedure are guaranteed to be proper/appropriate with respect to the data extraction examples. The program synthesis procedure also executes quickly. The program synthesis procedure can also be combined with other program synthesis methods which would allow users to extract relational data from spreadsheets having ad hoc, in-cell encodings.

### 2.1 Domain-Specific Query Language and Resulting Relational Data Extraction Programs

This section provides a more detailed description of the query language of the data extraction technique embodiments described herein and the relational data extraction programs that can result there-from. As described heretofore, a spreadsheet can store many different types of data in one or more two-dimensional arrays of cells which are known as worksheets. Each worksheet is organized in rows and columns, and the contents of a given cell in the spreadsheet can be based on the contents of one or more other cells in the spreadsheet. Generally speaking and as will be appreciated from the more detailed description that follows, the query language is domain-specific and pattern-based, and can be used by a programmer to manually create a program that automatically extracts relational data from the spreadsheet and outputs the extracted relational data in the form of a relational table. More particularly, this program automatically extracts a set of tuples of each intended relation from the spreadsheet and stores each of the tuples in this set in a different row of a results relational table. The query language thus allows users to express relational data queries against semi-structured, two-dimensional spreadsheet data and extract the resulting relational data into results relational tables.

Additionally, the query language of the data extraction technique embodiments described herein is two-dimensional in that it can combine one or more cell constraints with one or more spatial constraints. Each of the cell constraints is expressed as a conventional regular expression and places a constraint on the contents of cells in the spreadsheet. Generally speaking and as is appreciated in the art of computing, a regular expression is a sequence of characters that forms a search pattern. It will also be appreciated that different columns in the relational table that is output by the query language can contain different types of data. Many conventional spreadsheets do not have data types in the sense of a conventional programming language. Referring again to FIG. 2, it is nonetheless clear that column B and column C in the spreadsheet shown in FIG. 2 contain strings of data that are categorically different. The use of regular expressions to express the cell constraints provides a useful way to differentiate such strings of data. However, regular expressions by themselves are insufficient to differentiate such strings of data since regular expressions cannot express relationships between various elements of tuples of relational data. Each of the spatial constraints places a constraint on the relative position of a particular ordered pair of cells in the spreadsheet (e.g., each spatial constraint expresses a spatial relationship between a particular ordered pair of cells in the spreadsheet).

Just as regular expressions can produce a sequence of matching strings of data, the programs resulting from the data extraction technique embodiments can produce a set of tuples that includes the contents of cells in the spreadsheet which match the just-described cell and spatial constraints. The query language can thus be thought of as a spatial pattern language that allows a programmer to declaratively specify a set of constraints that define a transformation of the spreadsheet data into a desired relational format. As will be appreciated from the more detailed description that follows, intended queries in the query language are generally made up of a sequence of regular expressions with one or more contextual constraints around the regular expressions and one or more spatial constraints between the regular expressions. The program synthesis procedure of the data extraction technique embodiments can thus automatically generate such queries.

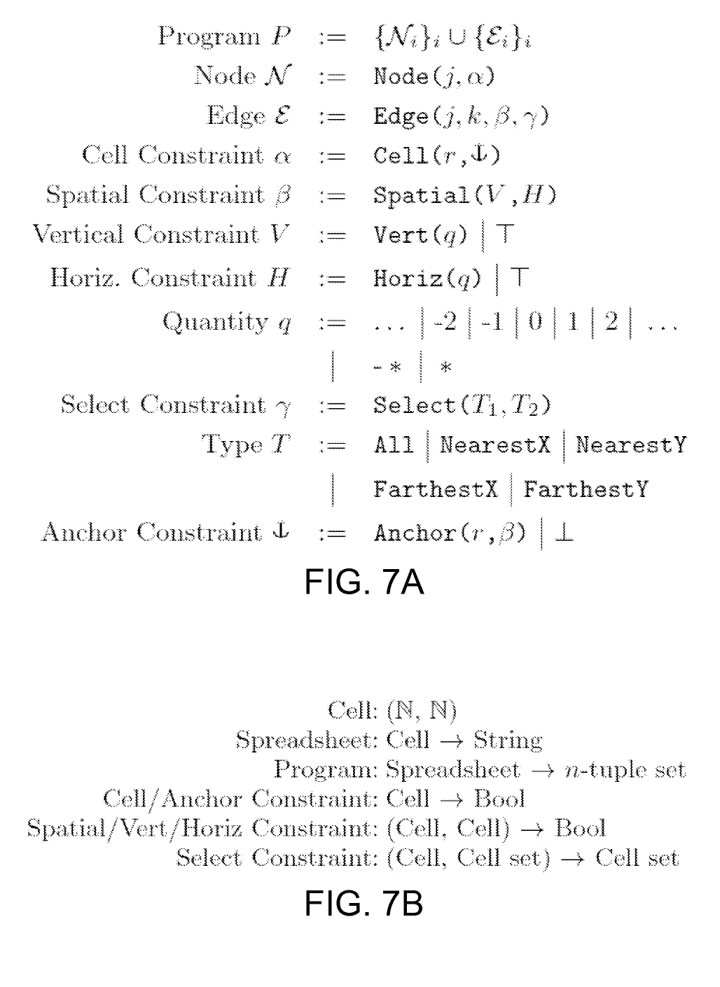

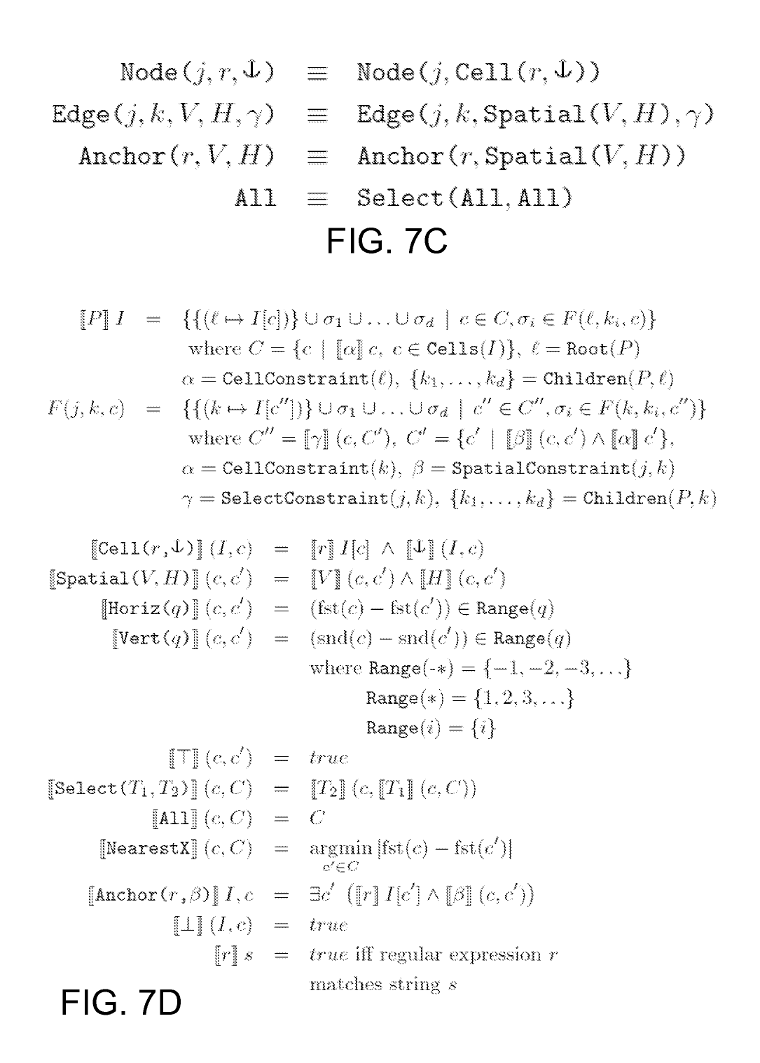

FIG. 7A illustrates an exemplary embodiment, in simplified form, of the syntax of the query language of the data extraction technique embodiments described herein. FIG. 7B illustrates an exemplary embodiment, in simplified form, of the types that are used in the query language. FIG. 7C illustrates an exemplary embodiment, in simplified form, of a shorthand syntax that is used in the query language for notational convenience. More particularly, the shorthand syntax that is shown on the left side of FIG. 7C is used to denote the expressions that are shown on the right side of FIG. 7C. FIG. 7D illustrates an exemplary embodiment, in simplified form, of the semantics of the query language. I denotes a given spreadsheet that includes a two-dimensional collection of strings of data. P denotes a given relational data extraction program that is generated by the data extraction technique embodiments described herein. x and y denote coordinates in the spreadsheet I. c denotes a given cell in I. C denotes a given set of cells in I. The term Cells(I) denotes all of the cells in the used range of I. Cell c can be represented by a pair of x and y coordinates in I. Accordingly, the x and y coordinates can be used to index the various cells in I (e.g., I[c]). a and b denote integers. v denotes a Boolean expression. * denotes a conventional Kleene star (also known as a Kleene operator).

As will now be described in more detail, the query language allows a given spreadsheet I to be transformed into an n-ary relational table (herein also referred to as a results relational table), which is a set of n-ary tuples of relational strings of data that have been extracted from the spreadsheet. In other words, a given relational data extraction program P transforms the spreadsheet I into an n-ary relational table (a results relational table). sᵢ denotes a given one of such relational strings of data. Each of such tuples can also be represented as a map from tuple attribute indices {1, . . . , n} to such relational strings of data (e.g., {1 [symbol] sᵢ, 2 [symbol] s₂, . . . , n [symbol] sₙ}).

As exemplified in FIG. 7A, a given relational data extraction program P is made up of n nodes (n being greater than or equal to one) and a set of directed edges. As will be described in more detail hereafter, each of the directed edges connects a different ordered pair of the nodes. In other words, each of the nodes in P except the root node is paired with one directed edge for which the node is the destination. Accordingly, these nodes and directed edges form a tree structure. These nodes and directed edges are labeled with descriptions that form the criteria for extracting a set of tuples of relational data from a given spreadsheet I. Each of the nodes in P is associated with a different tuple attribute index i from the results relational table, and corresponds to a cell constraint α. Each of the cell constraints α is a Boolean constraint over the contents of cells c in I and is denoted by CellConstraint(i). Accordingly, a given cell constraint α constrains the cells c whose contents are placed in a given column of the results relational table. Each of the directed edges in P is associated with a different ordered pair of tuple attribute indices j and k from the results relational table, and corresponds to a spatial constraint β. Each of the spatial constraints β is a Boolean constraint over the spatial relationship between a particular ordered pair of cells c in I and is denoted by SpatialConstraint(j,k). Accordingly, a given spatial constraint β constrains the relative positions of cells c whose contents are placed in the same row and in a given ordered pair of columns of the results relational table. The full set of the spatial constraints β induces a spanning tree over all of the columns of the results relational table. Each of the spatial constraints β may also include a select constraint γ, which, as will be described in more detail hereafter, specifies a distance-based filter over a set of cells C in I with respect to another cell c in I, and is denoted by SelectConstraint(j,k). The term Root(P) denotes the tuple attribute index corresponding to the root node in the tree structure that is formed by the nodes and directed edges in P.

As exemplified in FIG. 7D, F(j,k,c) denotes a recursive function that takes as input a pair of tuple attribute indices j and k (which serves as an edge identifier) and a cell c, and outputs a set of m-tuples, where m is the number of nodes that are reachable from the directed edge that is identified by j and k. As will be appreciated from the more detailed description that follows, F(j,k,c) allows constructive semantics to be defined for the relational data extraction program P. F(j,k,c) is computed in the following three actions. First, a set C′ of all cells that satisfy both the spatial relationship to c that is defined by SpatialConstraint(j,k) and the cell pattern that is defined by CellConstraint(k). The set of cells C′ is then filtered to a subset C″ of cells that satisfy the SelectConstraint(j,k) relationship with c. Then, for each c″ ∈c″, the cross product of singleton c″ and the result of the recursive invocation of F along each of the directed edges originating from nodes having the tuple attribute index k and cell c″ (e.g., F(k,kᵢ,c″)) is computed and the union thereof is output, where kᵢ belongs to the set of children of node k (denoted by Children(P,k)).

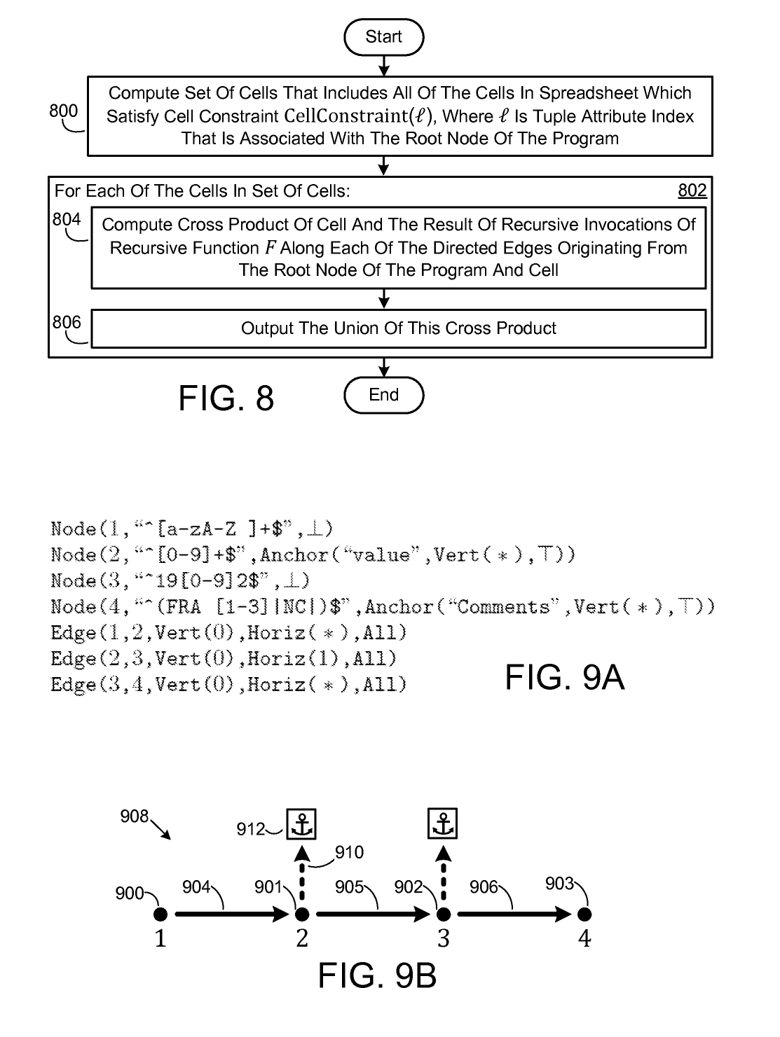

FIG. 8 illustrates an exemplary embodiment, in simplified form, of a process for executing a given relational data extraction program P on a given spreadsheet I. As exemplified in FIG. 8, the process starts in block 800 with computing a set of cells C that includes all of the cells c in the spreadsheet I which satisfy the cell constraint CellConstraint(l), where l is the tuple attribute index that is associated with the root node of the program P. The following actions then take place for each of the cells c in the set of cells C (e.g., for each c∈C) (block 802). The cross product of singleton c and the result of recursive invocations of the recursive function F along each of the directed edges originating from the root node of the program P and the cell c (e.g., F(l,kᵢ,c)) is computed (block 804). The union of this cross product is then output (block 806).

As also exemplified in FIG. 7A, each of the aforementioned cell constraints α can be represented by the term Cell(r, [symbol] ). A given cell constraint is made up of a regular expression r and may also include an anchor constraint [symbol] , where r specifies a Boolean constraint over strings of data in the spreadsheet I and [symbol] specifies a Boolean constraint over cells in I. A given anchor constraint [symbol] can be represented by the term Anchor(r,β) and thus is made up of a regular expression r and a spatial constraint β. Anchor(r,β) asserts that there exists a cell c′ in I whose content matches r and is related to the argument cell using the spatial constraint β. Anchor constraints can be thought of as a specialized case of the cell constraints and spatial constraints both of which just serve as a Boolean predicate but do not represent a column in the results relational table. Each of the spatial constraints β can be represented by the term Spatial(V,H) and thus is made up of a vertical constraint V and a horizontal constraint H. V is a Boolean constraint over an ordered pair of cells in I and checks if the pair of cells has the specified vertical orientation/relationship. H is also a Boolean constraint over the ordered pair of cells in I and checks if the pair of cells has the specified horizontal orientation/relationship.

As also exemplified in FIG. 7A, each of the aforementioned select constraints γ can be represented by the term Select(T₁,T₂) and thus is made up of a pair of enumerated Type tags, namely T₁ and T₂. A given tag Type (e.g., T₁ or T₂) can be either All, or NearestX, or NearestY, or FarthestX, or FarthestY, each of which specifies a different distance-based filter over a set of cells C in the spreadsheet I with respect to another cell c in I. More particularly, the tag NearestX selects those cells from C that have the shortest horizontal distance from c. The tag NearestY selects those cells from C that have the shortest vertical distance from c. The tag FarthestX selects those cells from C that have the longest horizontal distance from c. The tag FarthestY selects those cells from C that have the longest vertical distance from c. A given select constraint γ will often be made up of at most one constraint in the horizontal direction and at most one constraint in the vertical direction (e.g., just one of either NearestX or FarthestX, and just one of either NearestY or FarthestY).

As also exemplified in FIG. 7A, a quantity q attribute can have either any integer value or a Kleene star (“*”) value, and is used to control the meaning of both vertical constraints V and horizontal constraints H. A Kleene star value for q can match any cell in a particular direction, whereas integer values for q (in other words, constant quantities) just match cells in a particular location.

### 2.2 Execution of Exemplary Relational Data Extraction Program

In order to further the understanding of the data extraction technique embodiments described herein, this section provides an operational description, in simplified form, of the execution of an exemplary relational data extraction program P on an exemplary spreadsheet I.

FIG. 9A illustrates an exemplary embodiment, in simplified form, of a program P that can be generated by the data extraction technique embodiments described herein, where this program extracts relational data from the spreadsheet I shown in FIG. 3A and generates the results relational table which includes the extracted relational data shown in FIG. 4. FIG. 9B illustrates a tree representation of the program P shown in FIG. 9A. In order to convey the tree structure 908 of the program P shown in FIG. 9A, each cell constraint in FIG. 9B is shown as a numbered node (e.g., 901) and each spatial constraint in FIG. 9B is shown as an arrow (in other words, a directed edge) between an ordered pair of numbered nodes (e.g., 905). The nodes in FIG. 9B are numbered in the order that the program synthesis procedure of the data extraction technique embodiments generated them. The tree structure 908 shown in FIG. 9B also includes two anchor constraints which are shown as dashed lines (e.g., 910) connected to anchor symbols (e.g., 912). Referring again to FIG. 3B, the arrows (directed edges) that are labeled with an asterisk (*) represent spatial constraints having a variable distance.

The output of a given relational data extraction program P that is generated by the data extraction technique embodiments described herein (e.g., the results relational table that is generated by P) can generally be thought of as the concurrent solution of P's set of constraints for a spreadsheet I. As described herein and as exemplified in FIG. 9B, the nodes 900-903 and directed edges 904-906 in the program P shown in FIG. 9A form a tree structure 908. In other words, P is tree-shaped. Each of the nodes in P except the root node 900 is paired with one directed edge for which the node is the destination. More particularly, node 901 is paired with directed edge 904, node 902 is paired with directed edge 905, and node 903 is paired with directed edge 906. As described heretofore, each of the nodes 900-903 in P corresponds to a cell constraint that specifies a constraint over the contents of cells in I. Each of the directed edges 904-906 in P corresponds to a spatial constraint that specifies a constraint over the spatial relationship between a particular ordered pair of cells in I.

Referring again to FIGS. 9A and 9B, the relational data extraction program P is executed in the following manner. As is indicated by the first line of the program shown in FIG. 9A, all of the cells in the spreadsheet I are first filtered by the cell constraint for the root node 900 of P's tree structure 908, resulting in a set of filtered cells that are candidates for inclusion in the column of the results relational table having the tuple attribute index l. It is noted that each of the cells in this set of filtered cells is just a candidate for inclusion at this point because inclusion in the column of the results relational table having the tuple attribute index l is predicated on all of the other constraints for I being met. After all of the cells in I have been filtered as just described, as is indicated by the second through seventh lines of the program shown in FIG. 9A, the constraints corresponding to each of the directed edge and node pairs (904/901, 905/902 and 906/903) are recursively evaluated. In other words, for each subsequent directed edge and node pair in P's tree structure 908, P recursively outputs a new set of cells that satisfy the spatial constraint for the directed edge, starting from the cells that were output by the previous node and directed edge pair. This new set of cells is then filtered by applying the cell constraint for the node. The resulting filtered new set of cells become candidates for inclusion in the column of the results relational table having the tuple attribute index k.

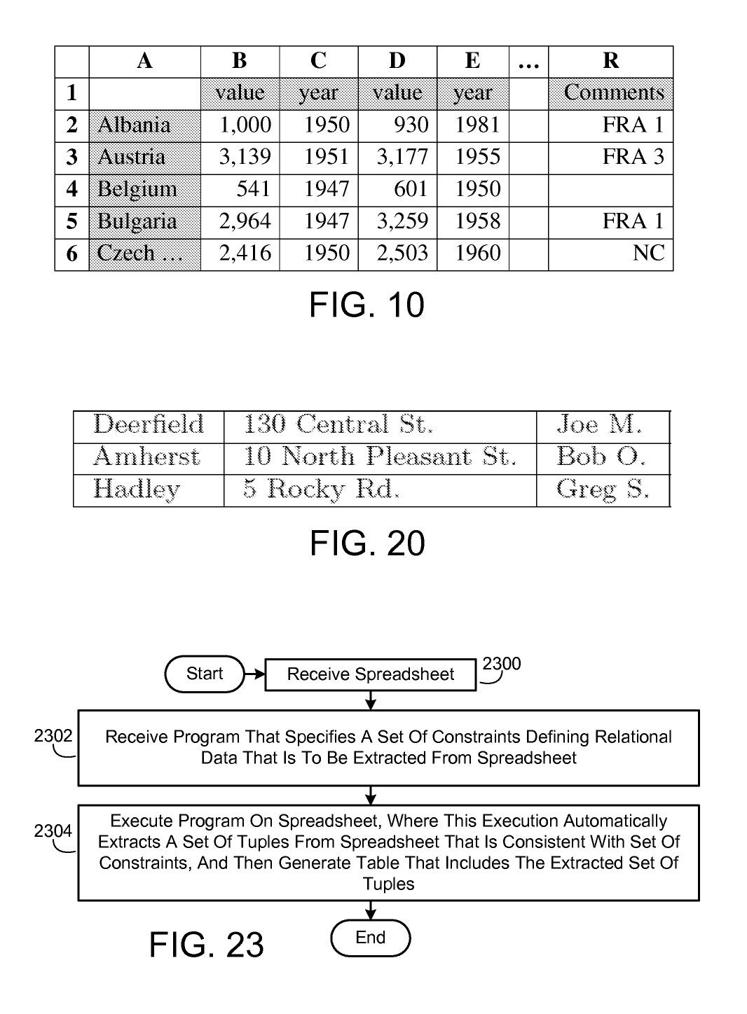

The first line of the program shown in FIG. 9A is:
Node(1,“̂[a−zA−Z]+$”,⊥).
   Referring again to FIG. 9B, this first line of the program specifies a cell constraint for the root node 1 (900) that filters the entire spreadsheet shown in FIG. 3A by applying the regular expression ̂[a−zA−Z]+$, and then by ensuring that all of the cells in the spreadsheet which match this expression also have neighbors that satisfy the anchor expression ⊥. The ⊥ anchor is a specialized case that means no anchor expression is given. As such, evaluating the ⊥ anchor for any cell in any spreadsheet will output true. After the first line of the program is executed (in other words, after the cell constraint for the root node is evaluated), the column having the tuple attribute index 1 in the results relational table will include the cells that are highlighted in FIG. 10.

The second line of the program shown in FIG. 9A is:
Node(2,“̂[0-9]+$”,Anchor(“value”,Vert(*),T)).
   Referring again to FIG. 9B, this second line of the program specifies a cell constraint for the node 2 (901) that includes both the regular expression ̂ [0-9]+$ and an anchor constraint Anchor(“value”,Vert(*),T). More particularly, the second line of the program first eliminates the cells that do not match ̂ [0-9]+$. It is noted that the relational data extraction programs that are generated by the data extraction technique embodiments described herein match regular expressions against the raw text values in a spreadsheet before the spreadsheet's formatting rules are applied. As such, the cell in the spreadsheet shown in FIG. 3A that includes the string of data “1,000” matches the regular expression ̂ [0-9]+$ despite the appearance of a “,” character in this string. The second line of the program then eliminates the cells that do not satisfy the anchor constraint Anchor(“value”,Vert(*),T) (in other words, just the cells that satisfy this anchor constraint are output). This particular anchor constraint states that a cell which includes the text “value” has to appear in the spreadsheet somewhere above the match.

Referring again to FIGS. 9A and 9B, the third line of the program shown in FIG. 9A specifies a cell constraint for the node 3 (902) that first eliminates the cells that do not match the regular expression ̂ 19 [0-9]2$, and then ensures that all of the cells which match this expression also have neighbors that satisfy the anchor expression ⊥. The fourth line of the program shown in FIG. 9A specifies a cell constraint for the node 4 (903) that first eliminates the cells that do not match the regular expression ̂ (FRA [1-3]|NC|)$, and then eliminates the cells that do not satisfy the anchor constraint Anchor(“Comments”,Vert(*),T) (in other words, just the cells that satisfy this anchor constraint are output). This particular anchor constraint states that a cell which includes the text “Comments” has to appear in the spreadsheet somewhere above the match.

The fifth line of the program shown in FIG. 9A is:
Edge(1,2,Vert(0),Horiz(*),All).
   Referring again to FIG. 9B, this fifth line of the program specifies a spatial constraint for the directed edge 904 that joins the root node 1 (900) with node 2 (901) (in other words, joins the column having the tuple attribute index 1 in the results relational table with the column having the tuple attribute index 2 in the results relational table). This spatial constraint states that the cells that are identified by the cell constraint for node 2 have to be anywhere to the right and not above or below the cells that are identified by the cell constraint for node 1. The sixth line of the program shown in FIG. 9A specifies a spatial constraint for the directed edge 905 that joins node 2 (901) with node 3 (902) (in other words, joins the column having the tuple attribute index 2 in the results relational table with the column having the tuple attribute index 3 in the results relational table). The seventh line of the program shown in FIG. 9A specifies a spatial constraint for the directed edge 906 that joins node 3 (902) with node 4 (903) (in other words, joins the column having the tuple attribute index 3 in the results relational table with the column having the tuple attribute index 4 in the results relational table).

Referring again to FIGS. 9A and 9B, the tree structure 908 of the relational data extraction program P shown in FIG. 9A dictates how the just-described cell mappings are combined to produce ordered tuples in the results relational table. Generally speaking, each of the parent cells is joined with each of its child cells, thus yielding a relational n-tuple. This is exemplified in the results relational table shown in FIG. 4.

### 2.3 Program Synthesis Procedure

This section provides a more detailed description of the program synthesis procedure of the data extraction technique embodiments described herein. As will be appreciated from the more detailed description that follows, the program synthesis procedure generally represents a programming by example technology that allows end-users with no programming experience (e.g., non-programmers) to create programs that extract relational data from spreadsheets by simply providing an objectives relational table that includes one or more data extraction examples. The program synthesis procedure thus enables end-users to leverage a rich set of data processing tools for relational data. The program synthesis procedure thus provides a tool that can be deployed for use by end-users in the real world.

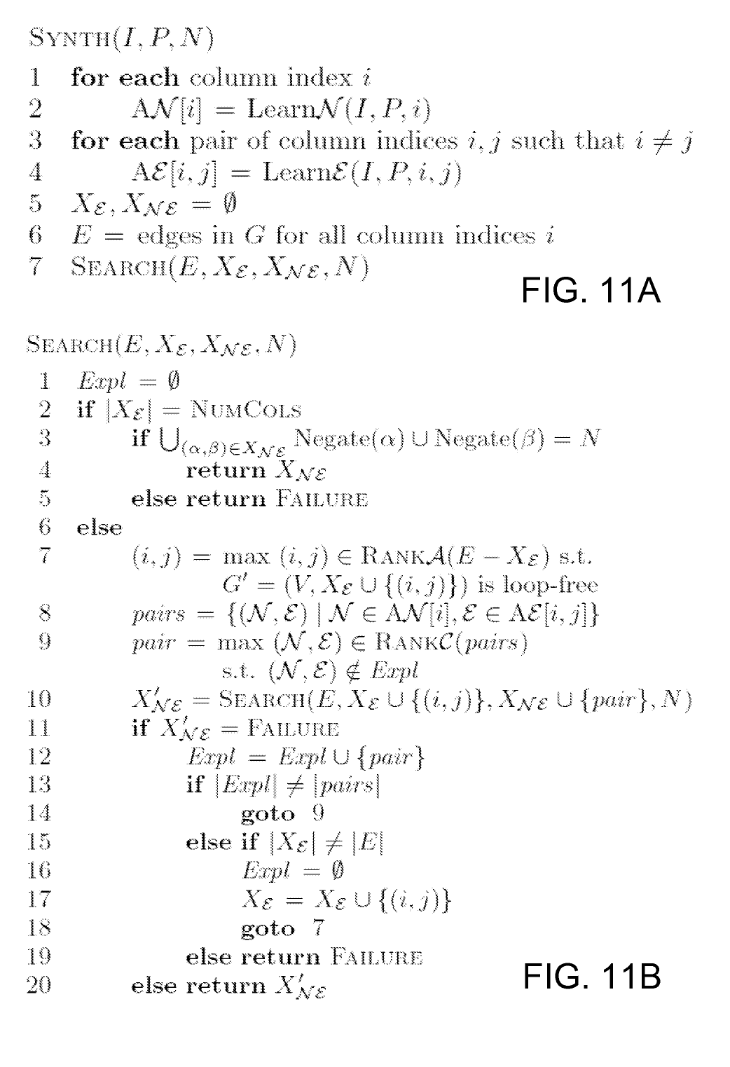

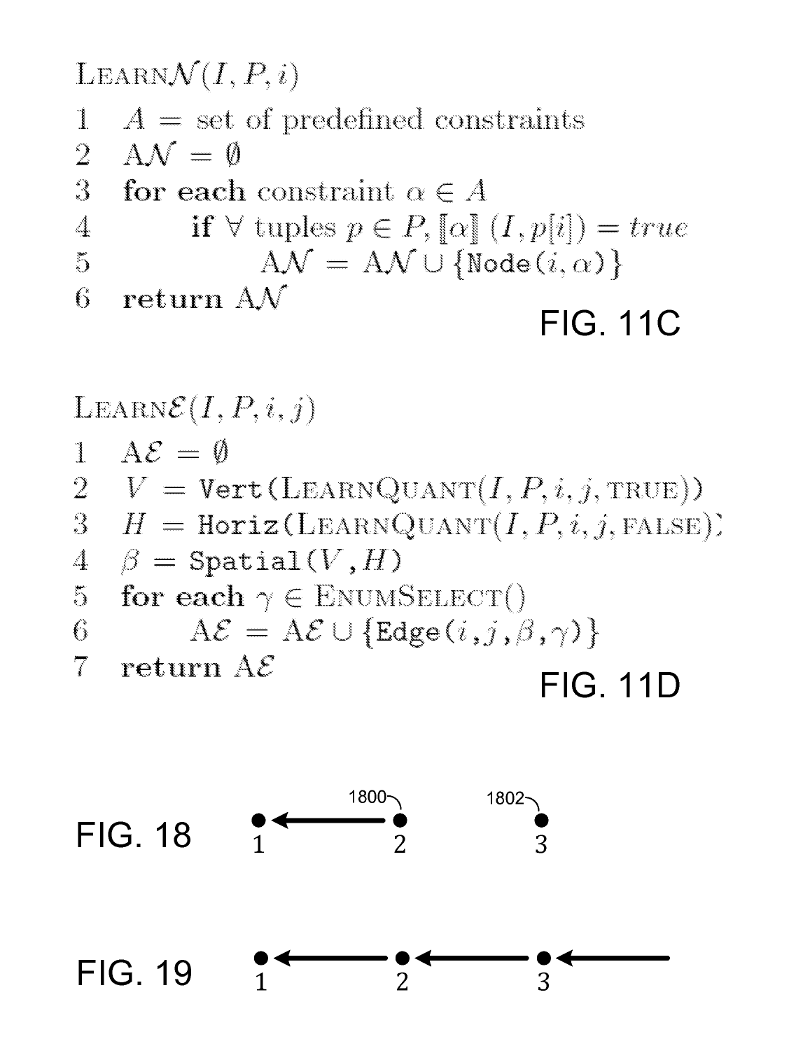

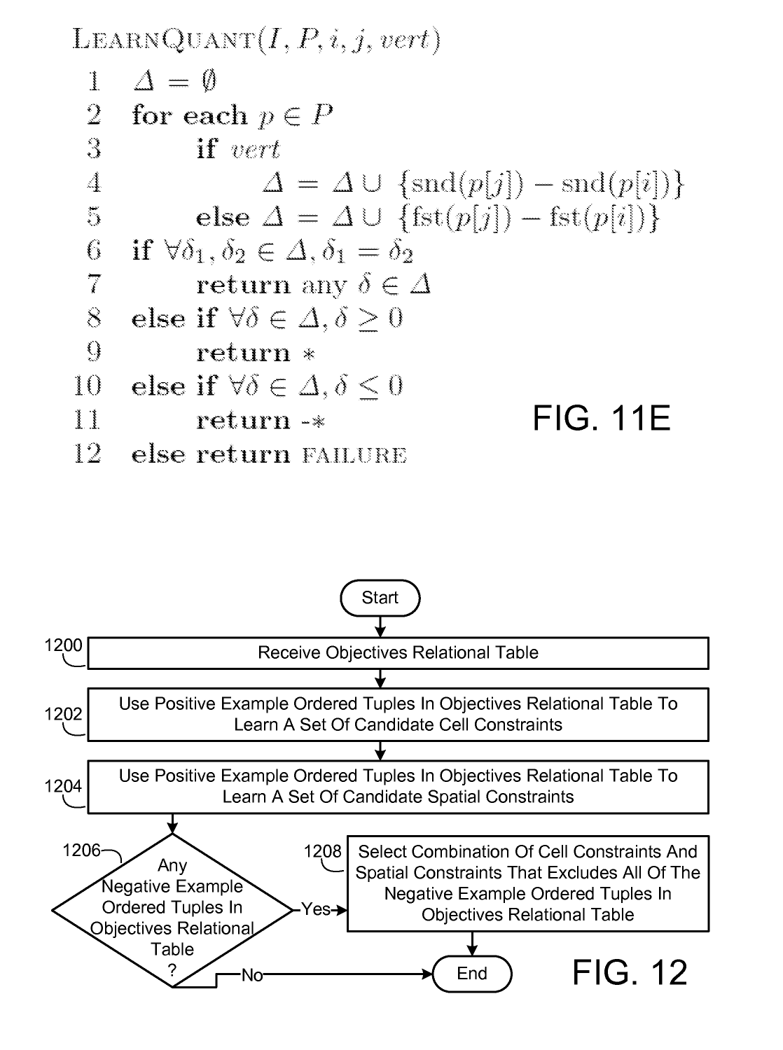

FIG. 11A illustrates an exemplary embodiment, in simplified form, of a program listing for a single iteration of the program synthesis procedure of the data extraction technique embodiments described herein. Generally speaking and as is described in more detail herein, the program listing SYNTH(I,P,N) shown in FIG. 11A automatically synthesizes a relational data extraction program that includes a set of cell constraints and a set of spatial constraints which are consistent with (e.g., satisfy) the objectives relational table that is provided by a user. As will be described in more detail hereafter, in an exemplary embodiment of the data extraction technique described herein the objectives relational table includes one or more examples of the kinds of relational data that the user desires to be extracted from a given spreadsheet. These examples include one or more positive example ordered tuples representing the kinds of relational data that the user wants to be extracted from the spreadsheet. These examples can optionally also include one or more negative example ordered tuples representing the kinds of relational data that the user does not want to be extracted from the spreadsheet.

FIG. 11B illustrates an exemplary embodiment, in simplified form, of a program listing for a search subroutine of the program listing SYNTH(I,P,N) shown in FIG. 11A. As will be described in more detail hereafter, the search subroutine SEARCH(E,X_{∈}, [symbol] ,N) is a modified version of (e.g., a recursive variant of) the conventional spanning tree procedure that was developed by Joseph Kruskal. SEARCH(E,X_{∈}, [symbol] ,N) generally operates by iteratively finding (e.g., building up) a spanning tree that satisfies the just-described data extraction examples. In other words, SEARCH(E,X_{∈}, [symbol] ,N) operates by recursively searching over all tree-shaped sets of the cell constraints and spatial constraints to find a spanning tree of cell constraints and spatial constraints that includes all of the positive example ordered tuples that are provided by the user, and excludes all of the negative example ordered tuples that are provided by the user. If the spanning tree that is found does not exclude all of the negative example ordered tuples, SEARCH(E,X_{∈}, [symbol] ,N) backtracks until it finds another spanning tree that does exclude all of the negative example ordered tuples. Since the number of these tree-shaped subsets can be quite large, SEARCH(E,X_{∈}, [symbol] ,N) can optionally use ranking heuristics to optimize its performance by ranking the cell constraints and spatial constraints before the just-described recursive searching is performed. These ranking heuristics will be described in more detail hereafter.

FIG. 11C illustrates an exemplary embodiment, in simplified form, of a program listing for a cell constraint learning subroutine of the program listing SYNTH(I,P,N) shown in FIG. 11A. In other words and as will be described in more detail hereafter, the cell constraint learning subroutine LEARN [symbol] (I,P,i) learns (e.g., selects) a set of cell constraints that is consistent with the objectives relational table. In other words, LEARN [symbol] (I,P,i) determines a cell constraint for each of the program's nodes. FIG. 11D illustrates an exemplary embodiment, in simplified form, of a program listing for a spatial constraint learning subroutine of SYNTH(I,P,N). In other words and as will also be described in more detail hereafter, the spatial constraint learning subroutine LEARN∈(I,P,i,j) learns a set of spatial constraints that is consistent with the objectives relational table. In other words, LEARN∈(I,P,i,j) determines a spatial constraint for each of the program's directed edges. It is noted that the set of spatial constraints that is learned by LEARN∈(I,P,i,j) has to be strictly tree-shaped over the set of tuple attribute indices i and j. It is also noted that the ENUMSELECT( ) term shown in line 5 of FIG. 11D simply enumerates the set of all possible select constraints. FIG. 11E illustrates an exemplary embodiment, in simplified form, of a program listing for a subroutine that learns the direction and the amount of spacing between the examples.

In the program listings shown in FIGS. 11A-11E I denotes a user-provided spreadsheet. P denotes a set of positive example ordered tuples that are provided by a user (e.g., P represents the kinds of relational data that the user wants to be extracted from I). N denotes a set of negative example ordered tuples that can optionally be provided by the user (e.g., N represents the kinds of relational data that the user does not want to be extracted from I). NUMCOLS denotes the number of attribute indices in a tuple in P. G=(V, E) denotes the complete digraph over the tuple attribute indices in P (e.g., over the positive example ordered tuples in P). V denotes the set of tuple attribute indices, where each index number represents its position in a given tuple in the results relational table. E denotes a set of directed edges each of which is represented by a pair of tuple attribute indices (i,j). X_{∈}denotes the set of explored directed edges. [symbol] denotes the set of explored constraint pairs (α,β), where a is a Node(j,r, [symbol] ) constraint and β is an Edge(j,k,V,H,γ) constraint.

The following two expressions denote a shorthand for the negative example ordered tuples that are excluded by a given cell constraint and a given spatial constraint, respectively:

Negate(α)≡{n∈N|n∉[[α]](I,c),∀c∈I}

Negate(β)≡{n∈N|n∉[[β]](c,c′),∀c,c′∈I,c≠c′}.

FIG. 12 illustrates an exemplary embodiment, in simplified form, of a process for automatically synthesizing a given valid relational data extraction program. As exemplified in FIG. 12, the process starts in block 1200 with receiving an objectives relational table that includes one or more examples of the kinds of relational data that a user desires to be extracted from a given spreadsheet. As described heretofore, these data extraction examples include one or more positive example ordered tuples representing the kinds of relational data that the user wants to be extracted from the spreadsheet. These data extraction examples can optionally also include one or more negative example ordered tuples representing the kinds of relational data that the user does not want to be extracted from the spreadsheet. The positive example ordered tuples in the objectives relational table are then used to learn a set of candidate (e.g., possible) cell constraints (block 1202). The positive example ordered tuples in the objectives relational table are then used to learn a set of candidate spatial constraints (block 1204). Then, whenever the objectives relational table includes one or more negative example ordered tuples (block 1206, Yes), a combination of cell constraints and spatial constraints is selected that excludes all of the negative example ordered tuples in the objectives relational table and forms a tree structure over the pairs of corresponding attribute indices of the spatial constraints (block 1208). As will be described in more detail hereafter, the efficiency of this selection can optionally be optimized by using ranking heuristics. It will be appreciated that since all of the constraint candidates from A [symbol] and A∈ satisfy the positive example ordered tuples in the objectives relational table by construction, the program synthesis procedure of the data extraction technique embodiments described herein simply has to select a set of constraints that excludes all of the negative example ordered tuples that may be in the objectives relational table.

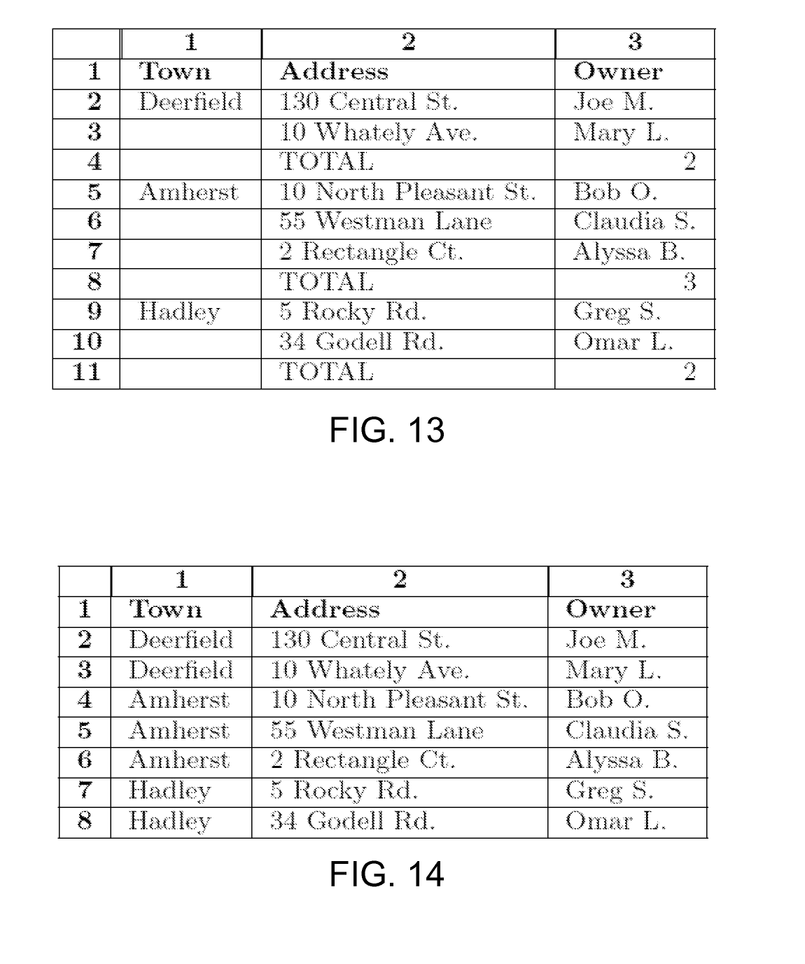

FIG. 13 illustrates an exemplary embodiment, in simplified form, of another spreadsheet. FIG. 14 illustrates an exemplary embodiment, in simplified form, of a results relational table that can be generated by an exemplary valid relational data extraction program which can be automatically synthesized to extract relational data from the spreadsheet shown in FIG. 13. In other words, the synthesized program transforms the spreadsheet shown in FIG. 13 into the results relational table shown in FIG. 14. The various actions involved in the synthesis of this program will now be described in more detail.

As will be appreciated from the program listing shown in FIG. 11A, the data provided in the aforementioned data extraction examples that are in the objectives relational table provided by the user determines which cell constraints and which spatial constraints will be learned. As will be appreciated from the program synthesis process implementations of the data extraction technique embodiments described herein that are described in more detail hereafter, the program synthesis procedure of the data extraction technique embodiments described herein is recursive and user-interactive. More particularly, after an initial iteration of the program listing SYNTH(I,P,N) shown in FIG. 11A is executed, if the user is unsatisfied with the results relational table that is generated by SYNTH(I,P,N) (e.g., if there are discrepancies between the objectives relational table and the results relational table), the user can provide a revised objectives relational table that may contain additional positive or negative example ordered tuples. Another iteration of SYNTH(I,P,N) can then be executed that will generate a revised results relational table. If the user is still unsatisfied with this revised results relational table, the user can provide another revised objectives table and yet another iteration of iteration of SYNTH(I,P,N) can be executed. This process can continue until the user is satisfied with the results relational table that is generated by SYNTH(I,P,N) (e.g., the process can continue until there are no discrepancies between the most recent objectives and results relational tables).

By way of example but not limitation, suppose that the user starts the program synthesis procedure of the data extraction technique embodiments described herein by providing an objectives relational table that includes the following single positive example ordered tuple:

| | | |
|---|---|---|
| Deerfield | 130 Central St. | Joe M. |

It is noted that this tuple also encodes the following map from its tuple attribute indices to coordinates in the spreadsheet shown in FIG. 13:
1→(1,2) 2→(2,2) 3→(3,2)
   It will be appreciated that the just-presented table representation of the single positive example ordered tuple is useful when reasoning about the tuple contents. The just-presented map representation of the single positive example ordered tuple is useful when reasoning about the spatial relationships between the tuple attribute indices.

### 2.3.1 Learning Cell Constraints

Referring again to FIGS. 11A, 11C and 12, this section provides a more detailed description of the aforementioned action of using the positive example ordered tuples in the objectives relational table to learn a set of candidate cell constraints (block 1202). Lines 1 and 2 of the program listing shown in FIG. 11A invoke the cell constraint learning subroutine LEARN [symbol] ( ) shown in FIG. 11C for each tuple attribute index i in the set of positive example ordered tuples P. As exemplified in FIG. 11C, LEARN [symbol] ( ) determines which cell constraints are possible for each cell belonging to tuple attribute index i in P. LEARN [symbol] ( ) uses a small set of commonly-occurring patterns that are derived from the aforementioned EUSES spreadsheet corpus. These patterns are combined with a simple method for learning new regular expressions from sequences (e.g., strings) of character classes. In an exemplary embodiment of the program synthesis procedure this regular expression learning method is based on the conventional method for automating string processing in spreadsheets using input-output examples. Regular expression learning methods are well understood in the art of computing. It will thus be appreciated that alternate embodiments of the program synthesis procedure are also possible where any other regular expression learning method that can learn from a set of positive example ordered tuples can be used.

As described heretofore, cell constraints may also include anchor constraints. In other words, when appropriate, the program synthesis procedure of the data extraction technique embodiments described herein may combine its set of candidate regular expressions with anchor constraints. In an exemplary embodiment of the program synthesis procedure these anchor constraints are synthesized in the following manner. Given a set of positive example cells having the tuple attribute index i, the neighbors of each of these positive example cells are searched for a string that is common to all similarly-located neighbor cells for all of the cells in i. If such a common neighbor is found, a procedure similar to the spatial constraint learning subroutine LEARN∈( ) shown in FIG. 11D is invoked to learn a Spatial( ) constraint. An Anchor( ) is output by combining the Spatial( ) constraint with a regular expression that is formed by the common string.

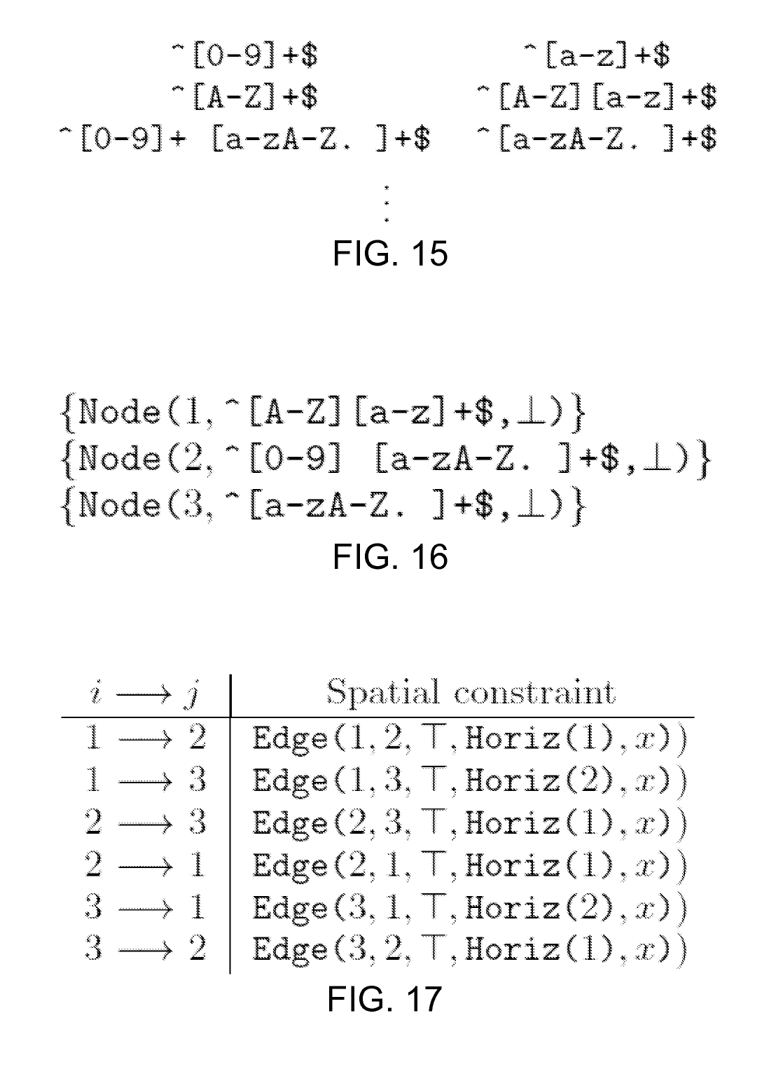

FIG. 15 illustrates an exemplary embodiment, in simplified form, of a partial set of regular expressions that can be learned by the aforementioned regular expression learning method and thus can be available to the program synthesis procedure of the data extraction technique embodiments described herein. FIG. 16 illustrates an exemplary embodiment, in simplified form, of a set of candidate cell constraints that can be learned by the cell constraint learning subroutine LEARN [symbol] ( ). In the case where the regular expressions shown in FIG. 15 are learned by the regular expression learning method, LEARN [symbol] ( ) will determine that the cell constraints shown in FIG. 16 satisfy each of the tuple attribute indices for the positive example ordered tuples that are provided by the user.

### 2.3.2 Learning Spatial Constraints

Referring again to FIGS. 11A, 11D, 11E and 12, this section provides a more detailed description of the aforementioned action of using the positive example ordered tuples in the objectives relational table to learn a set of candidate spatial constraints (block 1204). Lines 3 and 4 of the program listing shown in FIG. 11A invoke the spatial constraint learning subroutine LEARN∈( ) shown in FIG. 11D for each pair of column indices (i,j) in the set of positive example ordered tuples P. As exemplified in FIG. 11D, LEARN∈( ) determines spatial constraints that satisfy the observed spatial layout between columns in P.

As shown in FIGS. 11D and 11E, LEARN∈( ) first calculates the vertical and horizontal distances between two cells i and j in the same positive example ordered tuple, where these distances are the observed change in coordinates. These distances are then generalized across all of the positive example ordered tuples for the same two columns i and j, yielding a pair of Quantity statements, one for the horizontal direction and one for the vertical direction. The sign and source (e.g., vertical or horizontal) of each of the Quantity statements determines its direction, and this information is combined to form either a Vert( ) or Horiz( ) constraint. The Vert( ) and Horiz( ) constraints are combined with all possible MatchTypes to yield a set of candidate spatial constraints. It is noted that there are O(n²-n) possible spatial constraints (excluding self-loops) that can be found by LEARN∈( ), where n is the number of columns in the set of positive example ordered tuples P.

In an exemplary embodiment of the program synthesis procedure of the data extraction technique embodiments described herein learning in full generality during the execution of LEARN∈( ) is deferred for performance reasons. Rather, the execution performance of LEARN∈( ) is optimized by biasing the spatial constraint learning toward relational data extraction programs that do not have Kleene stars and that have shortest-match semantics. This biasing can be implemented as follows. A rule can be implemented stating that Kleene star is used in a given spatial constraint only when it is not possible to have the spatial constraint without Kleene star be consistent with the objectives relational table. Another rule can also be implemented stating that match-all semantics is used in a given spatial constraint only when it is not possible to have the spatial constraint without match-all semantics be consistent with the objectives relational table. It will be appreciated that these optimization rules are sound because LEARN∈( ) will explore the larger search space when necessary.

FIG. 17 illustrates an exemplary embodiment, in simplified form, of a set of candidate spatial constraints that LEARN∈( ) can learn from the single positive example ordered tuple shown in section 2.3 above.

2.3.3 Finding Set of Constraints that Satisfies Data Extraction Examples

Referring again to FIGS. 11A, 11B and 12, this section provides a more detailed description of the aforementioned action of selecting a combination of cell constraints and spatial constraints that excludes all of the negative example ordered tuples in the objectives relational table (block 1208). More particularly, line 7 of the program listing shown in FIG. 11A invokes the search subroutine SEARCH(E,X_{∈}, [symbol] ,N) shown in FIG. 11B which, as described heretofore, operates recursively to select some combination of the cell constraints and spatial constraints to form a relational data extraction program that satisfies the objectives relational table provided by the user. Generally speaking and as shown in lines 7-18 of the program listing shown in FIG. 11B, the constraint selection portion of SEARCH(E,X_{∈}, [symbol] ,N) is recursively executed in the following manner. A column pair (i,j) is chosen for exploration (line 7 of FIG. 11B). A cell constraint and spatial constraint pair are then chosen for exploration (line 9 of FIG. 11B). The next column pair (i,j) is then chosen for exploration (line 18 of FIG. 11B).

Referring again to FIG. 11B, in the case where SEARCH(E,X_{∈},X_{∈}, [symbol] ,N) is able to find a cell constraint and spatial constraint pair for each of the columns of the results relational table, where these selected constraint pairs exclude all of the negative example ordered tuples in the objectives relational table (hereafter simply referred to as a satisfactory set of constraints), the program synthesis procedure of the data extraction technique embodiments described herein has successfully synthesized a relational data extraction program that satisfies the objectives relational table. This program is then output and can be executed on the spreadsheet. In the case where SEARCH(E,X_{∈},X_{∈}, [symbol] ,N) is unable to find a set of cell constraint and spatial constraint pairs which satisfy the example ordered tuples in the objectives relational table, SEARCH(E,X_{∈},X_{∈}, [symbol] ,N) recursively backtracks until either it finds a satisfactory set of constraints, or it fails to do so.

### 2.3.4 Ranking Heuristics

This section provides a more detailed description of the aforementioned ranking heuristics. More particularly, this section provides a more detailed description of an attribute pair ranking heuristic RANK [symbol] ( ) and a constraint pair ranking heuristic RANK [symbol] ( ) As will be appreciated from the more detailed description that follows, these ranking heuristics are advantageous for various reasons including, but not limited to, the following. Using the ranking heuristics minimizes the execution time for the program synthesis procedure of the data extraction technique embodiments described herein. Using the ranking heuristics also minimizes the number of data extraction examples that a user has to provide in order for the program synthesis procedure to be able to automatically synthesize a relational data extraction program that satisfies the examples. In fact, when the ranking heuristics are used often times the program synthesis procedure can automatically synthesize a satisfactory program without the user having to provide any negative example ordered tuples.

As described heretofore, the examples of the kinds of relational data that a user desires to be extracted from a spreadsheet are provided in the form of ordered tuples. Given that Rect(i,j) denotes the smallest rectangle that encloses p[i] and p[j], and given that k, i, and j are tuple attribute indices, and given that P is a set of positive example ordered tuples, a heuristic for ranking pairs of tuple attribute indices (i,j) for exploration can be defined as follows:

Score(i,j)=|{p[k]∈Rect(i,j)|p∈P,k≠i,j}|.

The invocation of the attribute pair ranking heuristic RANK [symbol] ( ) on line 7 of the program listing shown in FIG. 11B uses this Score(i,j) heuristic. As such, the search subroutine SEARCH(E,X_{∈}, [symbol] ,N) appropriately selects the highest-ranked column pair.

FIG. 18 illustrates an exemplary embodiment, in simplified form, of an interim tree structure representation of a given relational data extraction program that is in the process of being synthesized by the program synthesis procedure of the data extraction technique embodiments described herein after a spatial constraint from node 2 to node 1 has been selected. More particularly, in the case where the execution of line 7 of the program listing shown in FIG. 11B selects the column pair 2→1, the explored tree structure would look like that which is shown in FIG. 18. It is noted that there is no directed edge between node/column 2 (1800) and node/column 3 (1802) because a spatial constraint from node 3 to node 2 has not yet been selected.

The invocation of the constraint pair ranking heuristic RANK [symbol] ( ) on line 9 of the program listing shown in FIG. 11B selects a pair of constraints as follows. All of the possible pairings of cell constraints and spatial constraints for tuple attribute indices i and j are ranked according to the following heuristics that consider the characteristics of the regular expressions that are associated with each pairing. Regular expressions having fewer Kleene stars are favored over (e.g., ranked higher than) regular expressions having more Kleene stars. Regular expressions having start-of-line (̂) and end-of-line ($) positional tokens are favored over regular expressions that do not have these tokens. Longer regular expressions are favored over shorter regular expressions.

The following is an exemplary set of candidate spatial constraints for the pair of tuple attribute indices (2,1):
1|Edge(2,1,Vert(0),Horiz(−1),All)
2|Edge(2,1,Vert(0),Horiz(−1),Nearest)
3|Edge(2,1,Vert(0),Horiz(−1),Farthest)
   In the case where SEARCH(E,X_{∈}, [symbol] ,N) selects constraint 2 shown above, after verifying that it satisfies all of the positive example ordered tuples (it does), SEARCH(E,X_{∈}, [symbol] ,N) then has to update the set of available candidate pairs of tuple attribute indices for future selections. More particularly, since the relational data extraction programs that are automatically synthesized by the program synthesis procedure of the data extraction technique embodiments described herein are tree-shaped as described heretofore, any directed edges that would either introduce a cycle or convert the programs' tree structure into a directed acyclic graph have to be removed from future consideration by SEARCH(E,X_{∈}, [symbol] ,N).

The just-described process of selecting i→j columns pairs continues until a spanning tree of cell constraints and spatial constraints is found. The final constraint that is selected by SEARCH(E,X_{∈}, [symbol] ,N) is thus a cell constraint for the root node, which is node 3 (1802) in the interim tree structure shown in FIG. 18. The root node can only be paired with the meaningless spatial constraint Edge(0,3,⊥,⊥,All) whose sole purpose is to simplify a synthesized program's satisfaction check.

FIG. 19 illustrates an exemplary embodiment, in simplified form, of a completed tree structure representation of a candidate relational data extraction program that has been automatically synthesized by the program synthesis procedure of the data extraction technique embodiments described herein. More particularly, FIG. 19 illustrates a completed version of the interim tree structure shown in FIG. 18.

The final action in SEARCH(E,X_{∈}, [symbol] ,N) is to determine whether the set of cell constraint and spatial constraint pairs that has been selected excludes all of the negative example ordered tuples in the objectives relational table. This action is shown on line 3 of the program listing shown in FIG. 11B. In other words, in order for the set of cell constraint and spatial constraint pairs that has been selected by SEARCH (E,X_{∈}, [symbol] ,N) to satisfy the objectives relational table, the following equation has to be true:

$${⋃}_{( α , β ) ∈ {X}_{𝒩 ℰ}} Negate ( α ) ⋃ Negate ( β ) = N .$$

If this union equation is not true, SEARCH(E,X_{∈}, [symbol] ,N) backtracks (as shown on line 5 of the program listing shown in FIG. 11B) to a previous search state and repeats the process of selecting i→j columns pairs until another spanning tree of cell constraints and spatial constraints is found. This process is iterated until either the program synthesis procedure of the data extraction technique embodiments described herein converges on a set of cell constraint and spatial constraint pairs that makes the above union equation true, or all spanning trees have been explored, or a prescribed period of time has passed.

FIG. 20 illustrates an exemplary embodiment, in simplified form, of a results relational table that can be generated by the data extraction technique embodiments described herein when the single positive example ordered tuple shown in section 2.3 above is used to extract relational data from the spreadsheet shown in FIG. 13. Since the user has provided no negative example ordered tuples, the union equation shown above is trivially found to be true and the relational data extraction program that was synthesized by the program synthesis procedure of the data extraction technique embodiments generates the results relational table shown in FIG. 20 and outputs it to the user, where this table has one row that includes this single positive example ordered tuple (as it is found on row 2 of the spreadsheet shown in FIG. 13) and two other rows that include tuples of relational data from rows 5 and 9 of the spreadsheet shown in FIG. 13. The results relational table shown in FIG. 20 excludes the TOTAL rows of the spreadsheet shown in FIG. 13 (namely, rows 4, 8 and 11) as the user wanted. However, upon the user reviewing the results relational table shown in FIG. 20, they will determine that this table does provide the data extraction result that they intended since the synthesized program did not properly/appropriately deal with the rows of the spreadsheet shown in FIG. 13 where the Town attribute is omitted (namely, rows 3, 6, 7, and 10). The user will thus determine that they have to provide an additional positive example ordered tuple and restart the program synthesis procedure.

### 2.4 Data Extraction Processes

This section provides a more detailed description of several different processes for automatically extracting relational data from spreadsheets. More particularly, this section provides a more detailed description of the aforementioned program synthesis process implementations of the data extraction technique embodiments described herein which leverage the program synthesis procedure thereof. This section also provides a more detailed description of the aforementioned programming process implementation of the data extraction technique embodiments which leverages the query language thereof.

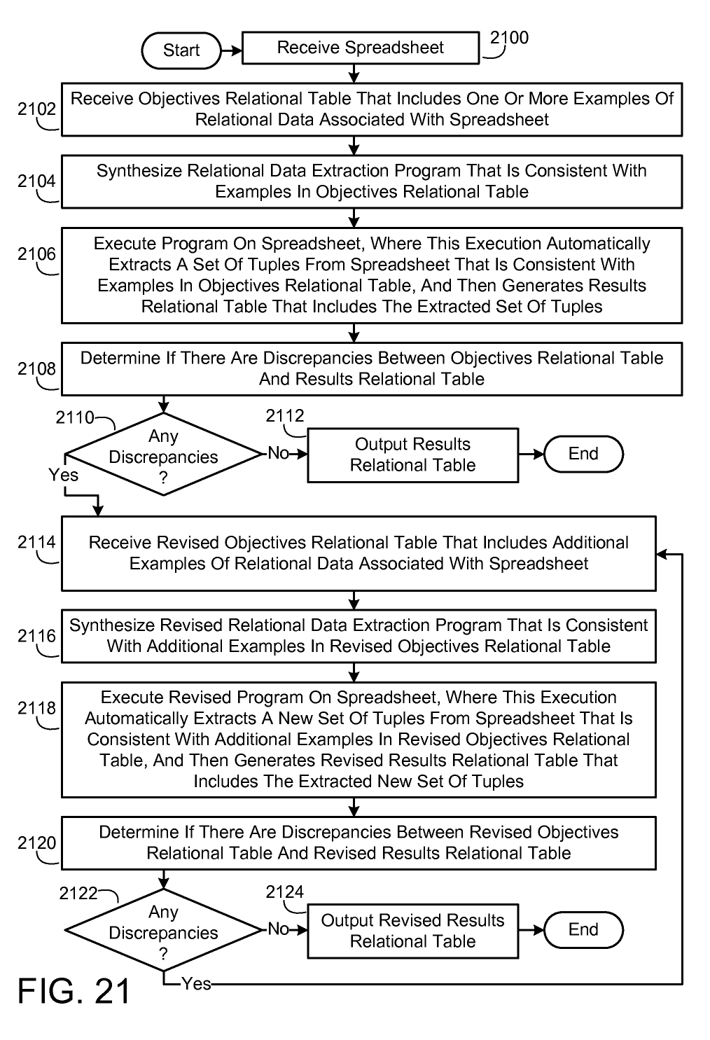

FIG. 21 illustrates one embodiment, in simplified form, of a process for automatically extracting relational data from a spreadsheet. As exemplified in FIG. 21, the process starts in block 2100 with receiving the spreadsheet. An objectives relational table is then received that includes one or more examples of the kinds of relational data that are associated with the spreadsheet (block 2102). A relational data extraction program that is consistent with the examples in the objectives relational table is then synthesized (block 2104). This program is then executed on the spreadsheet, where this execution automatically extracts a set of tuples from the spreadsheet that is consistent with the examples in the objectives relational table, and then generates a results relational table that includes the extracted set of tuples (block 2106). It is then determined if there are any discrepancies between the objectives relational table and the results relational table (block 2108). In an exemplary embodiment of the data extraction technique described herein this determination is made as follows. The results relational table is provided to a user, who compares the examples in the objectives relational table to the extracted set of tuples in the results relational table. The user then provides feedback as to any discrepancies they find between the objectives and results relational tables, where this feedback is in the form of a revised objectives relational table whenever there are discrepancies. Whenever there are no discrepancies between the objectives relational table and the results relational table (block 2110, No) (e.g., whenever the user determines that the examples in the objectives relational table sufficiently match the extracted set of tuples in the results relational table), the results relational table is output (block 2112).

As described heretofore, the examples of the kinds of relational data that are associated with the spreadsheet include one or more positive example ordered tuples representing the kinds of relational data that are to be extracted from the spreadsheet. These examples can optionally also include one or more negative example ordered tuples representing the kinds of relational data that are not to be extracted from the spreadsheet. Accordingly, the just-described action of automatically extracting a set of tuples from the spreadsheet that is consistent with the examples in the objectives relational table includes automatically extracting all tuples from the spreadsheet that include all of the positive example ordered tuples which are in the objectives relational table and do not include any of the negative example ordered tuples which may be in the objectives relational table. The just-described action of generating the results relational table includes storing each of the tuples in the extracted set of tuples in a different row of the results relational table.

Referring again to FIG. 21, whenever there are discrepancies between the objectives relational table and the results relational table (block 2110, Yes) (e.g., whenever the user determines that the examples in the objectives relational table do not sufficiently match the extracted set of tuples in the results relational table), the following actions can take place. A revised objectives relational table can be received that includes additional examples of the kinds of relational data that are associated with the spreadsheet (block 2114). As is described in more detail herein, these additional examples can include either one or more positive example ordered tuples, or one or more negative example ordered tuples, or any combination of positive example and negative example ordered tuples.

Referring again to FIG. 21, after the revised objectives relational table has been received (block 2114), a revised relational data extraction program that is consistent with the additional examples in the revised objectives relational table can then be synthesized (block 2116). This revised program can then be executed on the spreadsheet, where this execution automatically extracts a new set of tuples from the spreadsheet that are consistent with the additional examples in the revised objectives relational table, and then generates a revised results relational table that includes the extracted new set of tuples (block 2118). It can then be determined if there are any discrepancies between the revised objectives relational table and the revised results relational table (block 2120). In an exemplary embodiment of the data extraction technique described herein this determination is made as follows. The revised results relational table is provided to the user, who compares the additional examples in the revised objectives relational table to the extracted new set of tuples in the revised results relational table. The user then provides feedback as to any discrepancies they find between the revised objectives and revised results relational tables, where this feedback is in the form of another revised objectives relational table whenever there are discrepancies. Whenever there are no discrepancies between the revised objectives relational table and the revised results relational table (block 2122, No) (e.g., whenever the user determines that the additional examples in the revised objectives relational table sufficiently match the extracted new set of tuples in the revised results relational table), the revised results relational table can be output (block 2124). Whenever there are discrepancies between the revised objectives relational table and the revised results relational table (block 2122, Yes) (e.g., whenever the user determines that the additional examples in the revised objectives relational table do not sufficiently match the extracted new set of tuples in the revised results relational table), the actions of blocks 2114, 2116, 2118 and 2120 can be repeated.

As will be described in more detail hereafter and referring again to FIG. 21, the data extraction technique embodiments described herein are operational within numerous types of computing system configurations. By way of example but not limitation, the data extraction technique embodiments can be implemented using a single computing device (e.g., the user can be using the same computing device that is used to synthesize the relational data extraction program and execute it on the spreadsheet). In this case, the actions of blocks 2112 and 2124 can involve displaying the results and revised results relational tables on a display device of the single computing device. The data extraction technique embodiments can also be implemented using a client/server computing framework. In other words, the user can be using a client computing device (hereafter simply referred to as a client) and a server computing device (hereafter simply referred to as a server) can be used to synthesize the relational data extraction program and execute it on the spreadsheet. In this case, the actions of blocks 2112 and 2124 can involve transmitting the results and revised results relational tables to the client.

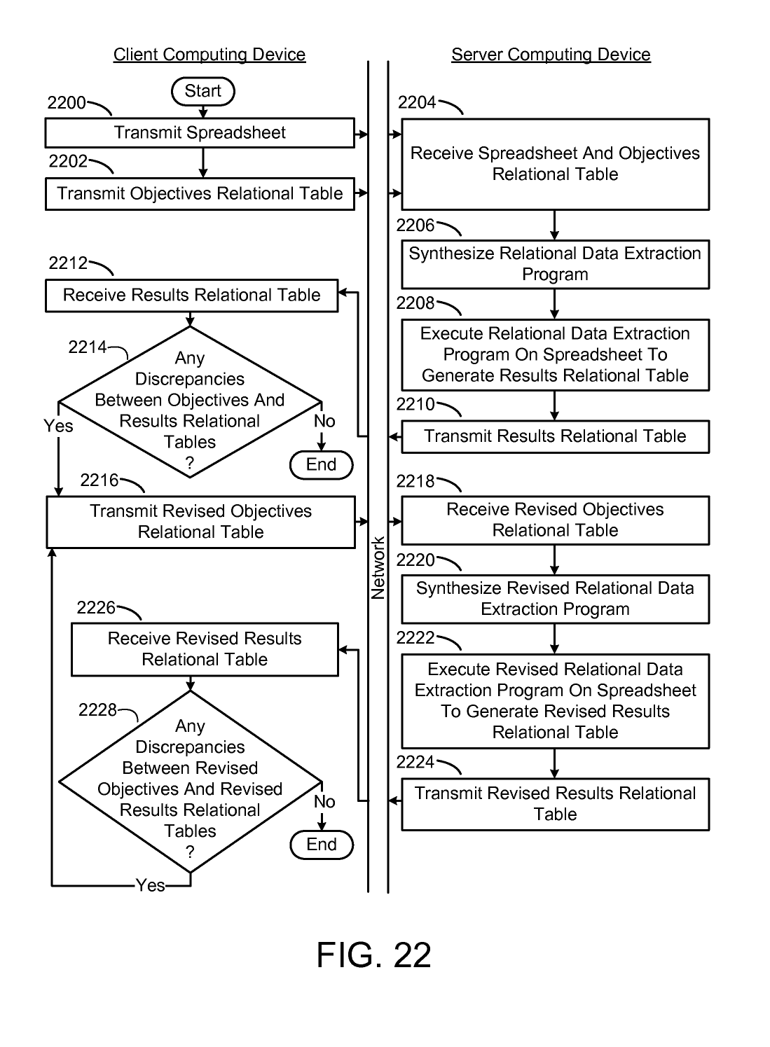

FIG. 22 illustrates an exemplary embodiment, in simplified form, of a process for automatically transforming relational data in a spreadsheet into a desired format. The process shown in FIG. 22 assumes that the data extraction technique embodiments described herein are implemented using a client/server computing framework where the user is using a client and a server is used to synthesize a relational data extraction program and execute it on the spreadsheet. As exemplified in FIG. 22, the process starts in block 2200 where upon the user inputting the spreadsheet to the client, the client transmits the spreadsheet over a network to the server. Then, upon the user inputting the aforementioned objectives relational table to the client, the client transmits the objectives relational table over the network to the server (block 2202). The server then receives the spreadsheet and objectives relational table from the client (block 2204), synthesizes a relational data extraction program that is consistent with the aforementioned examples in the objectives relational table (block 2206), executes this program on the spreadsheet to generate the aforementioned results relational table (block 2208), and transmits the results relational table over the network to the client (block 2210). The client then receives the results relational table (block 2212).

Referring again to FIG. 22, whenever there are discrepancies between the objectives relational table and the results relational table (block 2214, Yes), the following actions can take place. Upon the user inputting the aforementioned revised objectives relational table to the client, the client transmits the revised objectives relational table over the network to the server (block 2216). The server then receives the revised objectives relational table from the client (block 2218), synthesizes a revised relational data extraction program that is consistent with the aforementioned additional examples in the revised objectives relational table (block 2220), executes this program on the spreadsheet to generate the aforementioned revised results relational table (block 2222), and transmits the revised results relational table over the network to the client (block 2224). The client then receives the revised results relational table (block 2226). Whenever there are discrepancies between the revised objectives relational table and the revised results relational table (block 2228, Yes), the actions of blocks 2216, 2218, 2220, 2222, 2224 and 2226 can be repeated.

FIG. 23 illustrates another embodiment, in simplified form, of a process for automatically extracting relational data from a spreadsheet. As exemplified in FIG. 23, the process starts in block 2300 with receiving the spreadsheet. A program is then received that specifies a set of constraints defining relational data that is to be extracted from the spreadsheet (block 2302), where this set of constraints includes one or more cell constraints and one or more spatial constraints. As described heretofore, this program can be manually created using the query language of the data extraction technique embodiments described herein. In an exemplary embodiment of the data extraction technique the set of constraints is specified by a sequence of expressions in the program. Each of the cell constraints includes a regular expression that places a Boolean constraint over the contents of cells in the spreadsheet. A given cell constraint may also include an anchor constraint that is made up of a regular expression and a spatial constraint. Each of the spatial constraints includes a vertical constraint and a horizontal constraint that together place a Boolean constraint over the spatial relationship between a particular ordered pair of cells in the spreadsheet. A given spatial constraint may also include a select constraint that specifies a pair of distance-based filters over a set of cells in the spreadsheet with respect to another cell in the spreadsheet. The program is then executed on the spreadsheet, where this execution automatically extracts a set of tuples from the spreadsheet that is consistent with the set of constraints, and then generates a table that includes the extracted set of tuples (block 2304).

### 3.0 Additional Embodiments

While the data extraction technique has been described by specific reference to embodiments thereof, it is understood that variations and modifications thereof can be made without departing from the true spirit and scope of the data extraction technique. By way of example but not limitation, rather than the aforementioned examples of the kinds of relational data that the user desires to be extracted from a given spreadsheet including one or more positive example ordered tuples and optionally also including one or more negative example ordered tuples, an alternate embodiment of the data extraction technique is possible where these examples of the kinds of relational data that the user desires to be extracted can include one or more negative example ordered tuples and can optionally also include one or more positive example ordered tuples. Additionally, after a relational data extraction program that is consistent with the examples in the objectives relational table has been synthesized, the user can store this program for future use. Later on, the user can execute the stored program either on the particular spreadsheet that is associated with the objectives relational table, or on one or more other spreadsheets having an arrangement of data that is similar to this particular spreadsheet.

It is also noted that any or all of the aforementioned embodiments can be used in any combination desired to form additional hybrid embodiments. Although the data extraction technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 4.0 Exemplary Operating Environments

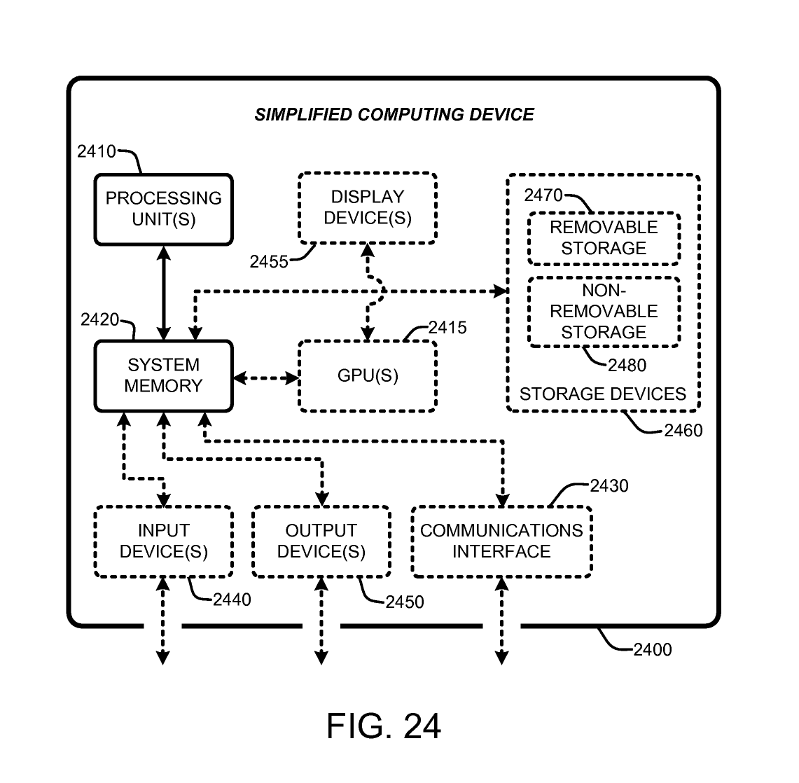

The data extraction technique embodiments described herein are operational within numerous types of general purpose or special purpose computing system environments or configurations. FIG. 24 illustrates a simplified example of a general-purpose computer system on which various embodiments and elements of the data extraction technique, as described herein, may be implemented. It is noted that any boxes that are represented by broken or dashed lines in the simplified computing device 2400 shown in FIG. 24 represent alternate embodiments of the simplified computing device. As described below, any or all of these alternate embodiments may be used in combination with other alternate embodiments that are described throughout this document. The simplified computing device 2400 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the data extraction technique embodiments described herein, the device should have a sufficient computational capability and system memory to enable basic computational operations. In particular, the computational capability of the simplified computing device 2400 shown in FIG. 24 is generally illustrated by one or more processing unit(s) 2410, and may also include one or more graphics processing units (GPUs) 2415, either or both in communication with system memory 2420. Note that that the processing unit(s) 2410 of the simplified computing device 2400 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 2400 shown in FIG. 24 may also include other components such as a communications interface 2430. The simplified computing device 2400 may also include one or more conventional computer input devices 2440 (e.g., pointing devices, keyboards, audio (e.g., voice) input devices, video input devices, haptic input devices, gesture recognition devices, devices for receiving wired or wireless data transmissions, and the like). The simplified computing device 2400 may also include other optional components such as one or more conventional computer output devices 2450 (e.g., display device(s) 2455, audio output devices, video output devices, devices for transmitting wired or wireless data transmissions, and the like). Note that typical communications interfaces 2430, input devices 2440, output devices 2450, and storage devices 2460 for general-purpose computers are well known to those skilled in the art, and will not be described in detail herein.

The simplified computing device 2400 shown in FIG. 24 may also include a variety of computer-readable media. Computer-readable media can be any available media that can be accessed by the computer 2400 via storage devices 2460, and can include both volatile and nonvolatile media that is either removable 2470 and/or non-removable 2480, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various data extraction technique embodiments described herein, or portions thereof, may be stored, received, transmitted, or read from any desired combination of computer-readable or machine-readable media or storage devices and communication media in the form of computer-executable instructions or other data structures.

Finally, the data extraction technique embodiments described herein may be further described in the general context of computer-executable instructions, such as program modules, being executed by a computing device. Generally, program modules include routines, programs, objects, components, data structures, and the like, that perform particular tasks or implement particular abstract data types. The data extraction technique embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Wherefore, what is claimed is:

1. A computer-implemented process for extracting relational data from a spreadsheet, comprising:
using a computer to perform the following process actions:
receiving the spreadsheet;
receiving an objectives relational table comprising one or more examples of relational data associated with the spreadsheet;
synthesizing a relational data extraction program that is consistent with said examples; and
executing the program on the spreadsheet, said execution comprising the actions of automatically extracting a set of tuples from the spreadsheet that is consistent with said examples, and generating a results relational table comprising the extracted set of tuples.

2. The process of claim 1, further comprising the actions of:
determining if there are discrepancies between the objectives relational table and the results relational table; and
whenever there are discrepancies between the objectives relational table and the results relational table,
receiving a revised objectives relational table comprising additional examples of relational data associated with the spreadsheet,
synthesizing a revised relational data extraction program that is consistent with said additional examples,
executing said revised program on the spreadsheet, said execution comprising the actions of automatically extracting a new set of tuples from the spreadsheet that is consistent with said additional examples, and generating a revised results relational table comprising the extracted new set of tuples, and
outputting the revised results relational table.

3. The process of claim 2, wherein the action of determining if there are discrepancies between the objectives relational table and the results relational table comprises the actions of:
providing the results relational table to a user; and
receiving feedback from the user as to any discrepancies between the objectives relational table and the results relational table, said feedback being in the form of the revised objectives relational table whenever there are discrepancies.

4. The process of claim 1, wherein the examples of relational data associated with the spreadsheet comprise one or more positive example ordered tuples representing relational data that is to be extracted from the spreadsheet.

5. The process of claim 4, wherein the examples of relational data associated with the spreadsheet further comprise one or more negative example ordered tuples in addition to said positive example ordered tuples, each of the negative example ordered tuples representing relational data that is not to be extracted from the spreadsheet.

6. The process of claim 1, wherein,
the examples of relational data associated with the spreadsheet comprise one or more positive example ordered tuples representing relational data that is to be extracted from the spreadsheet, and one or more negative example ordered tuples representing relational data that is not to be extracted from the spreadsheet, and
the action of automatically extracting a set of tuples from the spreadsheet that is consistent with said examples comprises an action of automatically extracting all tuples from the spreadsheet that comprise all of the positive example ordered tuples and do not comprise any of the negative example ordered tuples.

7. The process of claim 1, wherein the spreadsheet comprises an array of cells, the program comprises a plurality of nodes and a set of directed edges, each of the directed edges connects a different ordered pair of the nodes, the nodes comprise a root node, and the action of automatically extracting a set of tuples from the spreadsheet that is consistent with said examples comprises the actions of:
computing a set of cells comprising all of the cells in the spreadsheet which satisfy a cell constraint for the root node; and
for each of the cells in said set of cells,
computing the cross product of the cell and the result of recursive invocations of a recursive function along each of the directed edges originating from the root node and the cell, and
outputting the union of said cross product.

8. The process of claim 1, wherein the examples of relational data associated with the spreadsheet comprise one or more positive example ordered tuples representing relational data that is to be extracted from the spreadsheet, and one or more negative example ordered tuples representing relational data that is not to be extracted from the spreadsheet, and the action of synthesizing a relational data extraction program that is consistent with said examples comprises the actions of:
learning a set of cell constraints that is consistent with the objectives relational table;
learning a set of spatial constraints that is consistent with the objectives relational table; and
recursively searching over all tree-shaped sets of the cell constraints and spatial constraints to find a spanning tree of cell constraints and spatial constraints that comprises all of the positive example ordered tuples and excludes all of the negative example ordered tuples.

9. The process of claim 8, wherein the action of learning a set of spatial constraints that is consistent with the objectives relational table comprises the actions of:
implementing a rule stating that Kleene star is used in a given spatial constraint only when it is not possible to have the spatial constraint without Kleene star be consistent with the objectives relational table; and
implementing another rule stating that match-all semantics is used in a given spatial constraint only when it is not possible to have the spatial constraint without match-all semantics be consistent with the objectives relational table.

10. The process of claim 8, wherein the action of recursively searching over all tree-shaped sets of the cell constraints and spatial constraints to find a spanning tree of cell constraints and spatial constraints that comprises all of the positive example ordered tuples and excludes all of the negative example ordered tuples comprises an action of using ranking heuristics to rank the cell constraints and spatial constraints before said recursive searching is performed.

11. The process of claim 10, wherein the ranking heuristics comprise an attribute pair ranking heuristic and a constraint pair ranking heuristic.

12. A computer-implemented process for transforming relational data in a spreadsheet into a desired format, comprising:
using a computer to perform the following process actions:
transmitting the spreadsheet;
transmitting an objectives relational table comprising one or more examples of relational data associated with the spreadsheet; and
receiving a results relational table comprising a set of tuples that has been automatically extracted from the spreadsheet, said set being consistent with said examples.

13. The process of claim 12, further comprising the actions of, whenever there are discrepancies between the objectives relational table and the results relational table:
transmitting a revised objectives relational table comprising additional examples of relational data associated with the spreadsheet; and
receiving a revised results relational table comprising a new set of tuples that has been automatically extracted from the spreadsheet, said new set being consistent with said additional examples.

14. The process of claim 12, wherein the examples of relational data associated with the spreadsheet comprise one or more positive example ordered tuples representing relational data that is to be extracted from the spreadsheet.

15. The process of claim 14, wherein the examples of relational data associated with the spreadsheet further comprise one or more negative example ordered tuples in addition to said positive example ordered tuples, each of the negative example ordered tuples representing relational data that is not to be extracted from the spreadsheet.

16. A computer-implemented process for extracting relational data from a spreadsheet, comprising:
using a computer to perform the following process actions:
receiving the spreadsheet;
receiving a program that specifies a set of constraints defining relational data that is to be extracted from the spreadsheet, said set of constraints comprising one or more cell constraints and one or more spatial constraints; and
executing the program on the spreadsheet, said execution comprising the actions of automatically extracting a set of tuples from the spreadsheet that is consistent with said set of constraints, and generating a table comprising the extracted set of tuples.

17. The process of claim 16, wherein each of the cell constraints comprises a regular expression that places a Boolean constraint over the contents of cells in the spreadsheet.

18. The process of claim 17, wherein a given cell constraint further comprises an anchor constraint comprising a regular expression and a spatial constraint.

19. The process of claim 16, wherein each of the spatial constraints comprises a vertical constraint and a horizontal constraint that together place a Boolean constraint over the spatial relationship between a particular ordered pair of cells in the spreadsheet.

20. The process of claim 19, wherein a given spatial constraint further comprises a select constraint that specifies a pair of distance-based filters over a set of cells in the spreadsheet with respect to another cell in the spreadsheet.
